(19) United States
(12) Patent Application Publication
(10) Pub. No.: US 2010/0141580 A1
(43) Pub. Date: Jun. 10, 2010

(54) PIEZO-ELECTRIC SENSING UNIT AND DATA INPUT DEVICE USING PIEZO-ELECTRIC SENSING

(76) Inventor: Eui Jin Oh, Daejeon (KR)

Correspondence Address: LEXYOUME IP GROUP, LLC, 5180 PARKSTONE DRIVE, SUITE 175, CHANTILLY, VA, 20151, US

(21) Appl. No.: 12/733,197

(22) PCT Filed: Aug. 22, 2008
(86) PCT No.: PCT/KR2008/004927

§ 371 Date: Feb. 12, 2010

(30) Foreign Application Priority Data
Aug. 22, 2007 (KR) 10-2007-00084335
Oct. 12, 2007 (KR) 10-2007-0103096
Oct. 12, 2007 (KR) 10-2007-0103097

(51) Int. Cl. G06F 3/033

(52) U.S. Cl. 345/158

(57) ABSTRACT

Disclosed herein is a piezoelectric sensing unit and a data input device using piezoelectric sensing. The data input device of the present invention includes a base, an input unit, first piezoelectric sensing parts, and a control unit. The input unit performs a first directional input in such a way that the input unit moves to one of first direction indicating locations arranged around a base location in radial directions at positions spaced apart from each other within a pre-determined input radius defined on the base. The first piezoelectric sensing parts are provided on respective moving paths of the input unit, so that when the first directional input is performed, the corresponding first piezoelectric sensing part is pressed by the input unit, thus generating a first sensing signal proportional to a pressing force. When the first sensing signal is greater than a preset value, the control unit extracts data, assigned to the corresponding first direction indicating location at which movement of the input unit is sensed, from a memory unit and inputs the data.

### TECHNICAL FIELD

The present invention relates, in general, to piezoelectric sensing units and data input devices using piezoelectric sensing and, more particularly, to a piezoelectric sensing unit and a data input device using piezoelectric sensing which improve sensing parts that sense directional inputs, thus enhancing the productivity, realizing a small-sized input device, and increasing the operational reliability.

### BACKGROUND ART

Recently, with the rapid development of data processing technology, various information devices, such as mobile phones, computers, etc., have high performance, multifunctionality and are of a small size.

Typically, information devices include an input device to input data, a data processing device to process the input data, and an output device to output the processed data. In particular, importance of the input device is gradually increasing.

However, in current input devices, the input of various data, such as letters or instructions, presents many problems. For example, input devices, such as keyboards, used in personal computers (PCs) or notebook computers cause difficulty in realizing small-sized information devices because there is a limitation on the reduction in the size thereof, and touch screen schemes used in personal data assistants (PDAs) or keypad schemes used in mobile phones are inconvenient because the speed of input is relatively slow and the incidence of erroneous input is high.

In an effort to overcome the above-mentioned problems, the applicant of the present invention proposed input devices having input units capable of independently performing first directional inputs and second directional inputs in Korean Utility Model Application No. 2003-4588, entitled ‘Input device having input keys within moving radius of user's finger’, Korean Patent Application No. 2005-107743, entitled ‘Input device and character input method’ and Korean Patent Application No. 005-107715, entitled ‘Input device for information devices and character input method’.

However, in the above-mentioned conventional input devices, a separate sensor is required at every direction indicating location to sense the input operation of an input unit. Therefore, the production cost is increased, and because several sensors must be installed in a limited installation space, it is not easy to assemble the device, thus increasing the production time, thereby reducing the productivity.

Recently, piezoelectric sensing units are used to perform information storage or communication in such a way as to input data (for example, letters or the like) to various information devices, such as mobile phones, PDAs, etc., which are becoming small and diversified. Furthermore, the piezoelectric sensing units are also used as tactile sensors for humanoid robots which have functions similar to that of the human's skin.

The piezoelectric sensing units have spatial resolution. In the case where such a piezoelectric sensing unit is used as an input device for inputting data to an information device, the piezoelectric sensing unit senses a pressure from being pressed, generated when a user presses it using his/her finger, so that a control unit extracts data from a memory unit and inputs the data. If a piezoelectric sensing unit is used as a tactile sensor for humanoid robots, the piezoelectric sensing unit conducts functions similar to that of the human's skin (for example, functions of protecting a robot from external stimulation, and collecting various kinds of information, such as the hardness, surface material or temperature, from an object when the robot comes into physical contact with the object).

However, in the use of the conventional piezoelectric sensing units functioning as data input devices, there are several problems. In the case where the conventional piezoelectric sensing units are used as data input devices such as keyboards used in information devices, for example PCs (personal computers) or notebook computers, it is very difficult to realize small-sized information devices because of a limitation on the reduction in the size of the input devices.

Furthermore, in the case where the conventional piezoelectric sensing units are used as data input devices for PDAs (personal data assistant) or mobile phones, several separate sensors are required to sense a pressure resulting from a user pressing every pressing location. Thus, there is a disadvantage in that the production cost increases. As well, because the several sensors must be installed in a limited installation space, the assembly is complex, and the production time is increased, with the result that the productivity is reduced.

### DISCLOSURE OF INVENTION

### Technical Problem

Accordingly, the present invention has been made keeping in mind the above problems occurring in the prior art, and an object of the present invention is to provide a data input device which improves a sensing part that senses directional inputs, thus enhancing the productivity, realizing a small-sized input device, and increasing the operational reliability.

Another object of the present invention is to provide a piezoelectric sensing unit which improves a sensing part that senses a pressing pressure and thus can be used as a data input device which can be reduced in size and enhanced in productivity.

### Technical Solution

In order to accomplish the above objects, the present invention provides a data input device, including: a base; an input unit to perform a first directional input in such a way that the input unit moves to one of first direction indicating locations arranged around a base location in radial directions at positions spaced apart from each other within a predetermined input radius defined on the base; first piezoelectric sensing parts provided on respective moving paths of the input unit, so that when the first directional input is performed, the corresponding first piezoelectric sensing part is pressed by a pressing force by the input unit, thus generating a first sensing signal proportional to the pressing force; and a control unit to extract and input data from a memory unit when the first sensing signal is greater than a preset value, the data being assigned to the corresponding first direction indicating location at which movement of the input unit is sensed.

The first piezoelectric sensing parts may be provided between the base and the input unit at positions which correspond to the respective first direction indicating locations and are spaced apart from the input unit by predetermined distances.

The first piezoelectric sensing parts may be provided around an outer edge of the input unit and may be integrated with each other into a single body, and first deformation preventing depressions may be formed in the first piezoelectric sensing parts between the adjacent first direction indicating locations.

The data input device may further include a pressing ring provided between the first piezoelectric sensing parts and the input unit, the pressing ring having pressing protrusions which protrude towards the respective first piezoelectric sensing parts at positions corresponding to the respective first direction indicating locations.

The first piezoelectric sensing parts may form a sine wave shape in which concave recesses and convex portions are repeatedly formed, the concave recesses being formed in first surfaces of the first piezoelectric sensing parts, which face the base, at positions corresponding to the respective first direction indicating locations, the convex portions being formed on second surfaces of the first piezoelectric sensing parts such that the convex portions protrude towards the input unit.

The data input device may further include first contact sensing members provided on the base at positions corresponding to the respective concave recesses to detect a contact formed with the first piezoelectric sensing parts pushed by the pressing force of the input unit.

The data input device may further include a conductive elastic member provided on each of opposite surfaces of the first piezoelectric sensing parts.

The first directional input may be provided to be performed in two or more steps, that is, in multiple steps, depending on the intensity of a sensing signal sensed in the first piezoelectric sensing parts.

In order to accomplish the above objects, the present invention provides a data input device, including: a base; an input unit provided on the base, the input unit performing a second directional input in such a way that the input unit is tilted towards one of second direction indicating locations which are radially provided on the input unit at positions spaced apart from each other, or in such a way that one of push parts which are provided in the input unit at positions corresponding to the respective second direction indicating locations is selected; a second piezoelectric sensing part provided between the input unit and the base, the second piezoelectric sensing part generating a second sensing signal proportional to a tilting pressure of the input unit or a pushing pressure applied to the corresponding push part when the second directional input is performed; and a control unit to extract and input data from a memory unit when the second sensing signal is greater than a preset value, the data being assigned to the corresponding second direction indicating location at which the tilting of the input unit or the selection of the corresponding push part is sensed.

The second piezoelectric sensing part may include a plurality of second piezoelectric sensing parts which are provided below the input unit at positions corresponding to the respective second direction indicating locations.

The second piezoelectric sensing parts may be integrated with each other into a single body, and the second piezoelectric sensing parts may be demarcated by second deformation preventing depressions according to the respective second direction indicating locations.

The second piezoelectric sensing parts may be integrated with each other into a single body, in which spacing recesses are formed at positions corresponding to the respective second direction indicating locations.

The data input device may further include a second contact sensing member provided on the base in each of the spacing recesses to detect a contact with the corresponding second piezoelectric sensing part pushed by the tilting pressure of the input unit or by the pushing pressure of the corresponding push part.

The data input device may further include a conductive elastic member provided on each of opposite surfaces of the second piezoelectric sensing parts.

The second directional input may be provided to be performed in two or more steps, that is, in multiple steps, depending on the intensity of a sensing signal sensed in the second piezoelectric sensing parts.

The data input device may further include: a central input unit provided in a central portion of the input unit so as to be movable upwards and downwards, the central input unit performing a central input; and a third piezoelectric sensing part provided below the central input unit.

The third piezoelectric sensing part may be integrated with the second piezoelectric sensing part such that the second and third piezoelectric sensing parts are demarcated by a central deformation preventing depression.

The input unit may perform a first directional input in such a way that the input unit moves to one of first direction indicating locations which are arranged around a base location in radial directions at positions spaced apart from each other. The data input device may further include first piezoelectric sensing parts provided on respective roving paths of the input unit, so that when the first directional input is performed, the corresponding first piezoelectric sensing part is pressed by the input unit, thus generating a first sensing signal proportional to a pressing force.

The first piezoelectric sensing parts may be provided around an outer edge of the input unit and are integrated with each other into a single body, and first deformation preventing depressions may be formed in the first piezoelectric sensing parts between the adjacent first direction indicating locations.

The data input device may further include a pressing ring provided between the first piezoelectric sensing parts and the input unit, the pressing ring having pressing protrusions which protrude towards the respective first piezoelectric sensing parts at positions corresponding to the respective first direction indicating locations.

In order to accomplish the above objects, the present invention provides a data input device, including: an input unit provided so as to be tiltable from a horizontal state in first radial directions; a plurality of first piezoelectric sensing parts provided below the input unit at positions corresponding to the respective first radial directions, each of the first piezoelectric sensing parts generating a first sensing signal proportional to a tilting pressure of the input unit; a plurality of second piezoelectric sensing parts provided around outer edges of the first piezoelectric sensing parts at positions corresponding to respective second directions, each of the second piezoelectric sensing parts generating a second sensing signal proportional to a pushing pressure; a plurality of push parts provided on the respective second piezoelectric sensing parts; and a control unit to extract and input data from a memory unit when the first sensing signal or the second sensing signal is greater than a preset value, the data being assigned to the radial direction corresponding to the corresponding piezoelectric sensing part.

The first piezoelectric sensing parts and the second piezoelectric sensing parts may be integrated with each other, wherein circumferential deformation preventing depressions are formed between the first piezoelectric sensing parts and the second piezoelectric sensing parts, and radial deformation preventing depressions are formed between the adjacent first piezoelectric sensing parts and between the adjacent second piezoelectric sensing parts, thus demarcating the piezoelectric sensing parts.

The data input device may further include a plurality of pressing protrusions provided under the input unit, the pressing protrusions protruding towards the respective first piezoelectric sensing parts.

In addition, an upper surface of the input unit may be concave to correspond to a shape of a user's finger to be placed thereon.

The data input device may further include a manipulator protruding from an upper surface of the input unit to manipulate an operation of tilting the input unit.

The data input device may further include a pressing unit, having a coupling part, to which the manipulator is movably coupled, an extension part extending from the coupling part towards the second piezoelectric sensing parts, and a pressing part provided on an edge of the extension part to press the second piezoelectric sensing parts.

The data input device may further include: a third piezoelectric sensing part provided inside the first piezoelectric sensing parts at a position corresponding to a central portion of the input unit; and a central pressing protrusion provided under the input unit, the central pressing protrusion protruding towards the third piezoelectric sensing part.

As well, an outer edge of the input unit may extend towards the second piezoelectric sensing parts, and a bent part may be bent from the extension outer edge of the input unit towards sidewalls of the second piezoelectric sensing parts, so that when the input unit is horizontally moved in one direction, the bent part presses the sidewall of the corresponding second piezoelectric sensing part.

Furthermore, a deformation preventing depression may be formed in the second piezoelectric sensing parts at a position adjacent to the bent part.

In order to accomplish the above objects, the present invention provides a data input device, including: an input unit provided so as to be tiltable from a horizontal state in first radial directions, with an input protrusion provided centrally below the input unit, the input protrusion having a rod shape and extending downwards; a plurality of first piezoelectric sensing parts provided below the input unit at positions corresponding to the respective first radial directions, each of the first piezoelectric sensing parts generating a first sensing signal proportional to a tilting pressure of the input unit; a plurality of second piezoelectric sensing parts provided inside the first piezoelectric sensing parts and arranged in respective second radial directions, the second piezoelectric sensing parts surrounding the input protrusion, each of the second piezoelectric sensing parts generating a second sensing signal proportional to a pushing pressure generated by a horizontal movement of the input protrusion; a third piezoelectric sensing part provided on an end of the input protrusion, the third piezoelectric sensing part generating a third sensing signal proportional to a pushing pressure generated by a vertical movement of the input protrusion; and a control unit to extract and input data from a memory unit when the first, second or third sensing signal is greater than a preset value, the data being assigned to the radial direction corresponding to the corresponding piezoelectric sensing part or the input protrusion.

The first piezoelectric sensing parts and the second piezoelectric sensing parts may be integrated with each other, wherein circumferential deformation preventing depressions are formed between the first piezoelectric sensing parts and the second piezoelectric sensing parts, and radial deformation preventing depressions are formed between the adjacent first piezoelectric sensing parts and between the adjacent second piezoelectric sensing parts, thus demarcating the piezoelectric sensing parts.

The data input device may further include a plurality of pressing protrusions provided under the input unit, the pressing protrusions protruding towards the respective first piezoelectric sensing parts.

The second piezoelectric sensing parts may be spaced apart from the input protrusion by predetermined distances. The data input device may further include a returning part protruding from each of the second piezoelectric sensing parts towards the input protrusion, the returning part being made of elastic material, so that when the input unit is horizontally moved, the returning part returns the input protrusion to an initial position thereof.

The data input device may further include an extension protrusion provided on the end of the input protrusion, the extension protrusion extending towards the second piezoelectric sensing parts.

In order to accomplish the above objects, the present invention provides a piezoelectric sensing unit, including: a piezoelectric sensing part for forming a sensing area in which a plurality of pressing locations is distributed, the piezoelectric sensing part being made of elastic material and outputting a sensing signal proportional to a pressing force applied to one of the pressing locations; a conductive elastic member provided on a first side of the piezoelectric sensing part, the conductive elastic being connected to one of a grounding and a control unit; connection terminals provided on a second side of the piezoelectric sensing part at positions corresponding to the respective pressing locations, the connection terminals being connected to a remaining one of the grounding and the control unit; and the control unit to determine a pressing of the piezoelectric sensing part when the sensing signal transmitted to the control unit is greater than a preset value, the control unit determining the pressing location from the relevant connection terminal from which the sensing signal is transmitted to the control unit.

The piezoelectric sensing unit may further include a conductive elastic member provided on each of upper and lower surfaces of the piezoelectric sensing part.

The piezoelectric sensing part may be demarcated by deformation preventing depressions into portions corresponding to the respective pressing locations, thus preventing a pressing force applied to one of the pressing locations from being transmitted to the neighboring pressing locations.

The connection terminals may be provided into a checkerboard arrangement including a plurality of rows and lines crossing over each other, wherein intersecting points between the rows and lines correspond to the respective pressing locations.

The pressing locations may comprise a plurality of pressing locations arranged in the sensing area into a keypad type.

The pressing locations may be arranged around a base location in radial directions at positions spaced apart from each other by predetermined distances.

Furthermore, at least one of a letter, a numeral and a symbol may be assigned to each of the pressing locations.

In addition, two or more letters, numerals or symbols may be double-assigned to each of the pressing locations, and the control unit may discriminate the letters, numerals or symbols depending on intensities of sensing signals.

The piezoelectric sensing unit may further include a push plate provided on an upper surface of the piezoelectric sensing part at a position corresponding to each of the pressing locations to focus a pressing force on the corresponding pressing location.

As well, letters, numerals and symbols assigned to the respective pressing locations may be marked on the corresponding push plates.

The piezoelectric sensing unit may further include pressing protrusions provided on at least one of an upper surface of the piezoelectric sensing part and a lower surface of the piezoelectric sensing part which comes into contact with the connection terminals, each of the pressing protrusions focusing a pressing force on the corresponding pressing location.

The control unit may discriminate and determine the sensing signal output from the single pressing location as a two or more step signal, that is, a multiple step signal, depending on the intensity of the sensing signal.

The piezoelectric sensing unit may further include a clicking unit provided on the piezoelectric sensing part, the clicking unit providing a feeling of click to discriminate the intensity of the pressing force

The piezoelectric sensing part may be used in a touch pad, a touch screen or a skin of a robot.

In order to accomplish the above objects, the present invention provides a piezoelectric sensing unit, including: a conductive elastic member for forming a substrate; a plurality of piezoelectric sensing parts arranged in the conductive elastic member at positions spaced apart from each other, each of the piezoelectric sensing parts outputting a sensing signal proportional to a pressing force applied from an outside; a PCB provided below the piezoelectric sensing parts; connection terminals provided on one surface of the PCB which face the piezoelectric sensing parts at positions corresponding to the respective piezoelectric sensing parts, each of the connection terminals receiving the sensing signal from the corresponding piezoelectric sensing part; a film provided between the piezoelectric sensing parts and the PCB; conductive contact members provided in the film at positions corresponding to the respective piezoelectric sensing parts to electrically connect the piezoelectric sensing parts to the corresponding connection terminals; and a control unit to determine an occurrence of a pressing when the sensing signal is greater than a preset value, the control unit determining a pressing location from the relevant connection terminal from which the sensing signal is transmitted to the control unit.

In order to accomplish the above objects, the present invention provides a piezoelectric sensing unit, including: a piezoelectric sensing part having a plurality of conductive input plates on one surface thereof, the piezoelectric sensing part outputting a sensing signal proportional to a pressing force applied to each of conductive input plates; a PCB provided below the piezoelectric sensing part; connection terminals provided on one surface of the PCB which face the piezoelectric sensing part at positions corresponding to the respective conductive input plates, so that the sensing signal is transmitted from the piezoelectric sensing part to the corresponding connection terminal; and a control unit to determine an occurrence of a pressing when the sensing signal is greater than a preset value, the control unit determining a pressing location from the relevant conductive input plate from which the sensing signal is transmitted to the control unit.

### Advantageous Effects

In the data input device according to the present invention having the above-mentioned construction, piezoelectric sensing parts that sense directional inputs can be mass-produced by a forming method using a mild (or a die), thus enhancing the productivity, and realizing a small-sized data input device. In addition, the operational reliability of the device can be enhanced.

Furthermore, the data input device according to the present invention does not require several separate sensors corresponding to the number of first and second direction indicating locations, thus reducing the production cost.

In addition, it is not necessary to install several sensors on moving paths of an input unit or portions of the input unit corresponding to the respective second direction indicating locations, and the purposes of the present invention can be achieved only by mounting to the input unit the piezoelectric sensing part that can be formed using a mold. Therefore, the assembly of the data input device is simplified, and the production time is reduced, so that it can be easily adapted for mass production.

As well, in the case of the piezoelectric sensing part having an integrated structure, the structure of the data input device can be simplified and the size of the device can be thus reduced. Furthermore, unlike the complex conventional structure having several sensors, malfunction of the device is markedly reduced, thus enhancing the operational reliability.

Moreover, in the case where first piezoelectric sensing parts, second piezoelectric sensing parts and third piezoelectric sensing parts are integrally formed with each other, it is not necessary to provide several separate sensors for sensing respective directional inputs. Therefore, the production cost can be reduced, and the number of manufacturing processes can be minimized by an injection molding method or the like. In addition, the installation of the components can also become convenient, so that the productivity can be enhanced.

Meanwhile, a piezoelectric sensing unit according to the present invention improves a sensing part that senses a pressure resulting from being pressed and thus is able to be used as a data input device which can be reduced in size and enhanced in productivity.

### BRIEF DESCRIPTION OF THE DRAWINGS

FIG. 1 is a perspective view of a portable mobile communication terminal having a data input device, according to the present invention;

FIG. 2 is a block diaphragm of the data input device according to the present invention;

FIG. 3 is a plan view of a first piezoelectric sensing part according to an embodiment of the present invention;

FIG. 4 is a plan view of a first piezoelectric sensing part according to another embodiment of the present invention;

FIGS. 5 and 6 are plan views of a first piezoelectric sensing part according to another embodiment of the present invention;

FIG. 7 is a perspective view and a partial enlarged view of a second piezoelectric sensing part according to an embodiment of the present invention;

FIG. 8 is a plan view, a partial enlarged view and a sectional view of a second piezoelectric sensing part according to another embodiment of the present invention;

FIG. 9 is a plan view and a sectional view of a third piezoelectric sensing part according to an embodiment of the present invention;

FIG. 10 is a view showing a modification of a piezoelectric sensing part according to the present invention;

FIG. 11 is an exploded perspective view of a portable mobile communication terminal having a data input device, according to another embodiment of the present invention;

FIG. 12 is a sectional view showing the operation of the data input device of FIG. 11;

FIGS. 13 through 16 are sectional views showing data input devices according to various embodiments of the present invention;

FIG. 17 is a sectional view and a plan view showing deformation preventing depressions formed in a first piezoelectric sensing part of FIG. 16;

FIG. 18 is a sectional view of a data input device and a plan view of a piezoelectric sensing part according to another embodiment of the present invention;

FIG. 19 is a view showing a modification of a piezoelectric sensing part according to the present invention;

FIG. 20 is an exploded perspective view of a piezoelectric sensing unit according to an embodiment of the present invention;

FIG. 21 is an assembled sectional view taken along the line A-A of FIG. 20;

FIG. 22 is a sectional view of a piezoelectric sensing unit according to another embodiment of the present invention;

FIG. 23 is a sectional view of a piezoelectric sensing unit according to another embodiment of the present invention;

FIG. 24 is a perspective view of a piezoelectric sensing unit having a connection terminal according to another embodiment of the present invention;

FIG. 25 is a perspective view of a piezoelectric sensing unit having a connection terminal according to another embodiment of the present invention;

FIG. 26 is a perspective view of a piezoelectric sensing unit having a keypad type push plate according to another embodiment of the present invention;

FIG. 27 is a sectional view taken along the line B-B′ of FIG. 26;

FIG. 28 is a plan view showing push plates arranged into a radial shape at positions spaced apart from each other according to another embodiment of the present invention;

FIG. 29 is an exploded perspective view of a piezoelectric sensing unit in which piezoelectric sensing parts are arranged to form a keypad type structure according to another embodiment of the present invention;

FIG. 30 is an assembled sectional view taken along the line C-C′ of FIG. 29;

FIG. 31 is an exploded perspective view of a piezoelectric sensing unit having a conductive input plate according to another embodiment of the present invention; and

FIG. 31 is an assembled sectional view taken along the line D-D′ of FIG. 31.

### BEST MODE FOR CARRYING OUT THE INVENTION

Hereinafter, several embodiments of a data input device using piezoelectric sensing according to the present invention will be described in detail with reference to the attached drawings.

### First Embodiment

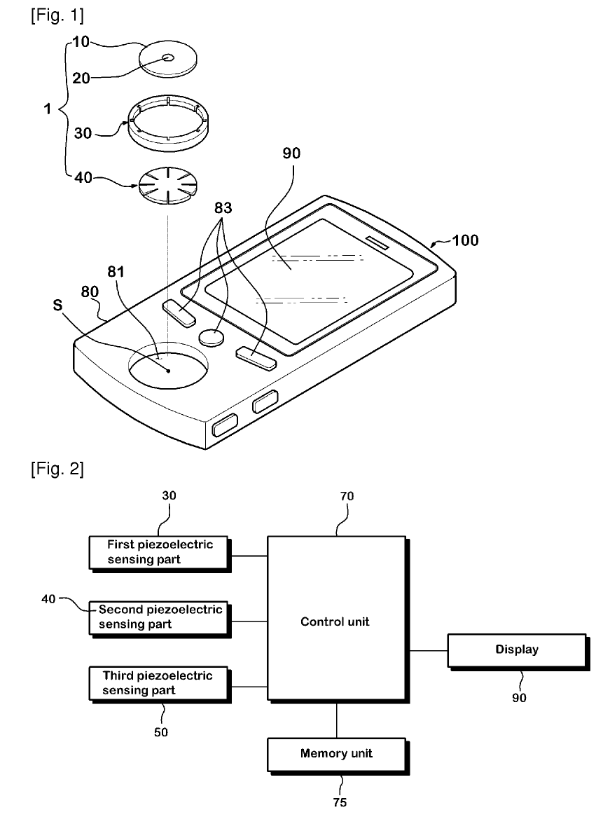

Referring to FIGS. 1 and 2, a data input device 1 according to a first embodiment of the present invention includes a base 110, and an input unit 10 which performs a first directional input M1 in such a way that the input unit 10 moves to one of first direction indicating locations M1₁, M1₂, M1₃, . . . which are arranged around a base location in radial directions at positions spaced apart from each other within a predetermined input radius provided on the base 110. The data input device 1 further includes a first piezoelectric sensing part 30, which is provided on each moving path of the input unit 10 and is pressed by the input unit 10 at the time of processing the first directional input M1 to generate a first sensing signal proportional to a pressing force. The data input device 1 further includes a control unit 70 which, when the first sensing signal is greater than a preset value, extracts from a memory unit 75 data assigned to a corresponding first direction indicating location M1₁, M1₂, M1₃, . . . at which the movement of the input unit 10 is sensed and inputs the data.

FIG. 1 is a perspective view illustrating a portable mobile communication terminal 100 having the data input device 1, according to the present invention. Referring to the drawing an input radius circle 81 having the base location is formed in a predetermined portion of the base 80. A display 90 which displays information input through the input unit 10 and various kinds of functional keys 83 are provided in another predetermined portion of the base 80.

The input unit 10 is capable of performing the first directional input M1 in such a way that the input unit 10 moves to one of the first direction indicating locations M1₁, M1₂, M1₃, . . . which are arranged around a base location in radial directions at positions spaced apart from each other within the input radius circle 81 provided on the base 110.

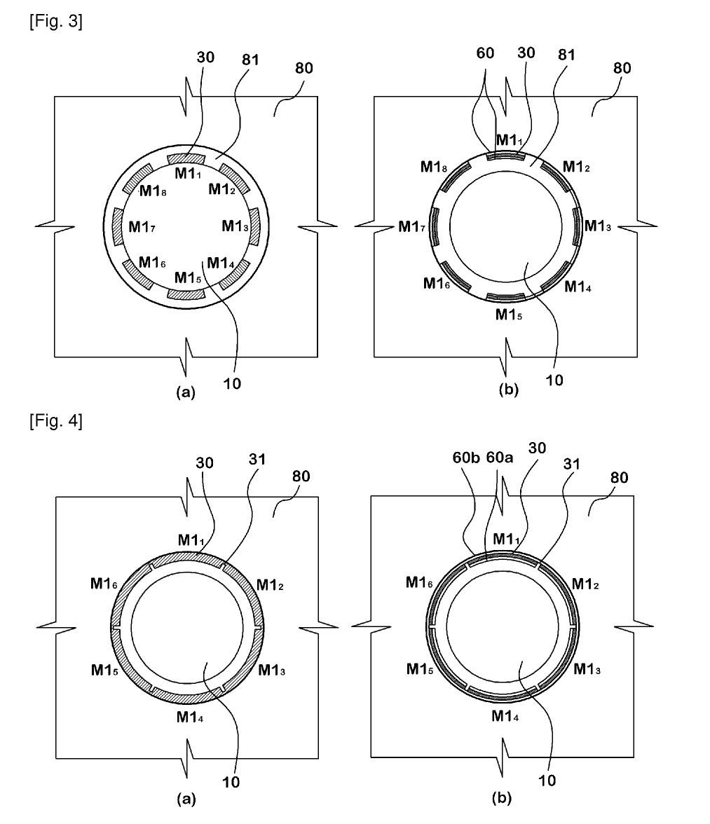

The number of first direction indicating locations M1₁, M1₂, M1₃, . . . may be variously changed as necessary. For example, as shown in FIG. 3, eight locations may be provided or, alternatively, as shown in FIG. 4, six locations may be provided.

A letter of a relevant country, a numeral, a symbol or a desired functional instruction or the like is assigned to each first direction indicating location M1₁, M1₂, M1₃, . . . . Thus, when the first directional input M1 is performed, data assigned to the corresponding first direction indicating location M1₁, M1₂, M1₃, . . . is extracted and performed by the control unit 70.

The first directional input M1 is performed in such a way as to move the input unit 10 from the base location to one selected from among the first direction indicating locations M1₁, M1₂, M1₃, . . . within the input radius circle 81.

Here, the first directional input M1 can be performed in various ways and, for example, it may be performed by horizontally moving or sliding the input unit 10 on the base 80. Alternatively, the input unit 10 may be constructed such that it protrudes from the base 80, so that the first directional input M1 may be performed by tilting the input unit 10 in one direction.

The first piezoelectric sensing part 30 is provided on the moving paths of the input unit 10 and is pressed by the input unit 10 at the time of the first directional input M1, thus generating a first sensing signal proportional to the pressing force.

The piezoelectric sensing part changes the output of electric current or voltage depending on a variation in resistance attributable to force applied from the outside. For example, a piezoelectric sensor may be used as the piezoelectric sensing part.

The first piezoelectric sensing part 30 is provided between the base 80 and the input unit 10 on the moving path of the input unit 10. As shown in FIG. 3, the first piezoelectric sensing part 30 may or may not be spaced apart from the outer edge of the input unit 10 by a predetermined distance.

In the latter case, the first piezoelectric sensing part 30 is in contact with the base 80 and the input unit 10, so that when pressing force is applied from the input unit 10, the first piezoelectric sensing part 30 elastically moves and thus outputs a varied current or voltage value.

The first piezoelectric sensing part 30 may have various shapes. For example, as shown in FIG. 3a, the first piezoelectric sensing part 30 may be provided along the outer edge of the input unit 10 or, alternatively, as shown in FIG. 3b, it may be provided on the base 80.

Furthermore, as shown in FIG. 3, the first piezoelectric sensing part 30 may comprise a plurality of first piezoelectric sensing parts 30 which correspond to the respective first direction indicating locations M1₁, M1₂, M1₃, . . . or, alternatively, as shown in FIG. 4, it may have an integrated structure and be formed into a single body.

In the case where the first piezoelectric sensing part 30 having an integrated structure is provided along the outer edge of the input unit 10, as shown in FIG. 4, first deformation preventing depressions 31 are respectively preferably formed between adjacent first direction indicating locations M1₁, M1₂, M1₃, . . . .

Each first deformation preventing depression 31 is formed between the corresponding adjacent first direction indicating locations M1₁, M1₂, M1₃, . . . and functions to prevent a pressing force applied to one of the first direction indicating locations M1₁, M1₂, M1₃, . . . from being undesirably applied to adjacent other first direction indicating locations M1₁, M1₂, M1₃, . . . . For example, as shown in FIG. 4, if a first directional input M1 is performed towards M1₁, the variation in shape of the first piezoelectric sensing part 30 attributable to the pressing of the input 10 may not be limited to the portion relevant to M1₁ but it may occur on M1₂ or M1₆.

If the distance between the adjacent first direction indicating locations M1₁, M1₂, M1₃, . . . is relatively short due to an increase in the number of first direction indicating locations M1₁, M1₂, M1₃, or the small size of the input unit 10 or the base 80, the transmission of the pressing force to the vicinity of the target portion may be further increased.

Hence, in the present invention, as shown in FIG. 4, the first deformation preventing depressions 31 are respectively formed between the adjacent first direction indicating locations M1₁, M1₂, M1₃, . . . , so that the variation in shape of the first piezoelectric sensing part 30 due to a pressing force applied to one of the first direction indicating locations M1₁, M1₂, M1₃, . . . is prevented from being transmitted to portions of the first piezoelectric sensing part 30 corresponding to the neighboring first direction indicating locations M1₁, M1₂, M1₃, . . . .

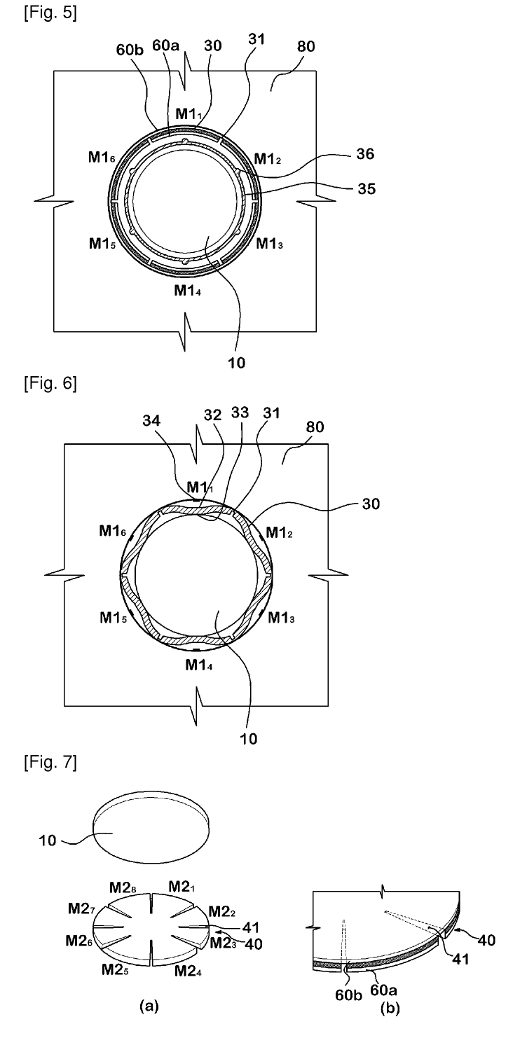

Meanwhile, as shown in FIG. 5, a pressing ring 35 may be provided between the first piezoelectric sensing part 30 and the input unit 10. The pressing ring 35 has pressing protrusions 36 which protrudes towards the first piezoelectric sensing part 30 at positions corresponding to the respective first direction indicating locations M1₁, M1₂, M1₃, . . . .

Each pressing protrusion 36 focuses the pressing force of the input unit 10 on the corresponding first piezoelectric sensing part 30 and thus partially varies in shape of the first piezoelectric sensing part 30. Therefore, an area in which the first piezoelectric sensing part 30 is varied in shape by pressing is reduced, but a rate of partial variation in shape attributable to the pressing is increased.

Here, the pressing protrusion 36 is not limited to the shape shown in FIG. 5 and can be modified into various shapes.

Meanwhile, in place of the separate pressing ring 35 provided between the first piezoelectric sensing part 30 and the input unit 10, pressing protrusions 36 having various shapes may be directly provided on the input unit 10 at positions corresponding to the first direction indicating locations M1₁, M1₂, M1₃, . . . .

Furthermore, the present invention may be constructed such that without having the first deformation preventing depressions 31, the control unit 70 compares sensing signal values transmitted from several first direction indicating locations M1₁, M1₂, M1₃, . . . of the first piezoelectric sensing part 30 and determines the largest sensing signal value as an available signal.

As shown in FIGS. 3b and 4b, a conductive elastic member 60 may be provided on each of the opposite surfaces of the first piezoelectric sensing part 30.

The conductive elastic members 60 cover the first piezoelectric sensing part 30 to prevent abrasion or mechanical damage to the first piezoelectric sensing part 30 and return the input unit 10 which has performed the first directional input M1 to the base location.

Here, in the case where the first deformation preventing depressions 31 are formed in the first piezoelectric sensing part 30, the first deformation preventing depressions 31 are also formed in the corresponding conductive elastic member 60, as shown in FIG. 4b or 5.

Meanwhile, as shown in FIG. 6, the first piezoelectric sensing part 30 may have a wave (a sine wave) shape in which concave recesses and convex portions are repeatedly formed in the first piezoelectric sensing part 30, the concave recesses being formed in a first surface of the first piezoelectric sensing part 30, which face the base 80, at positions corresponding to the respective first direction indicating locations M1₁, M1₂, M1₃, . . . , the convex portions being formed on a second surface of the first piezoelectric sensing part 30 such that they protrude towards the input unit 10.

In this case, only the convex portions 33 of the first piezoelectric sensing part 30 are in contact with the input unit 10. Thus, in the same manner as that of the above-stated pressing protrusions 36, an area in which the first piezoelectric sensing part 30 is varied in shape by pressing is reduced, but a rate of partial variation in shape attributable to the pressing is increased, thus increasing a sensing signal value.

Furthermore, the convex portions 33 and the concave recesses 32 are repeatedly varied in shape and restored between the input unit 10 and the base 80 and thus function to return the input unit 10 to its original position.

Here, a first contact sensing member 34 is provided in each concave recess 32 to detect a contact having been made with the first piezoelectric sensing part 30 being pushed by the input unit 10. In other words, a sensing signal is generated by the contraction and variation of the first piezoelectric sensing part 30, and a contact signal is generated by the variation and movement of the first piezoelectric sensing part 30. Therefore, additional data is assigned to the detection of the first contact sensing member 34, so that the number of data input by the first directional input M1 can be increased.

When the first sensing signal is greater than the preset value, the control unit 70 extracts, from the memory unit 75, data, which is assigned to the relevant first direction indicating location M1₁, M1₂, M1₃, . . . that detects the movement of the input unit 10, and inputs the data.

The control unit 70 is electrically connected to the portions of the first piezoelectric sensing part 30 corresponding to the respective first direction indicating locations M1₁, M1₂, M1₃, . . . . Hence, when the first directional input M1 is performed so that the first piezoelectric sensing part 30 is pressed and varied in shape by the pressing force of the input unit 10 and outputs a current or voltage value different from that in the normal conditions, the control unit 70 receives this and extracts, from the memory unit 75, data, which are assigned to a first direction indicating location M1₁, M1₂, M1₃, . . . corresponding to a portion of the first piezoelectric sensing part 30 that generates a varied output, and implements the relevant operation.

In this case, the first directional input M1 may be performed in two or more steps, that is, in multiple steps depending on the intensities of signals detected from the first piezoelectric sensing part 30.

In other words, after sensing signal values are set as two or more steps, the sensing signal values detected from the first piezoelectric sensing part 30 are compared to the preset value and a first step input and a second step input are separately performed.

In this case, if the number of first direction indicating locations M1₁, M1₂, M1₃, . . . is constant, the number of assigned data can be increased by the number of multiple step inputs. Thus, the capacity of input can be maximized.

### Second Embodiment

A data input device according to a second embodiment of the present invention will be described below. In the description of this embodiment, the same reference numerals are used to designate components corresponding to those of the first embodiment.

The data input device 1 according to the second embodiment of the present invention includes a base 80 and an input unit 10 which is provided on the base 80. The input unit 10 performs a second directional input M2 in a way as to tilt the input unit 10 towards one of second direction indicating locations M2₁, M2₂, M2₃, . . . which are radially provided on the input unit 10 at positions spaced apart from each other or in a way as to push one of push parts 45 which are provided in the input unit 10 at positions corresponding to the respective second direction indicating locations M2₁, M2₂, M2₃, . . . . The data input device 1 further includes a second piezoelectric sensing part 40 which is provided between the input unit 10 and the base 80 and generates a second sensing signal proportional to a tilting pressure of the input unit 10 or a pushing pressure applied to the push part 45 at the time of processing the second directional input M2. The data input device 1 further includes a control unit 70 which, when the second sensing signal is greater than a preset value, extracts from a memory unit 75 data assigned to a corresponding second direction indicating location M2₁, M2₂, M2₃, . . . , at which the tilting of the input unit 10 or the selection of the corresponding push part 45 is detected, and inputs the data.

In the following description of this embodiment, explanation overlapping with the above-stated embodiment will be omitted to focus on the differences between this embodiment and the above embodiment.

In the present invention, the term “second directional input M2” means that it is performed in a way as to tilt the input unit 10 towards one of the second direction indicating locations M2₁, M2₂, M2₃, . . . which are radially provided on the input unit 10 at positions spaced apart from each other or in a way as to select one of the push parts 45 which are provided in the input unit 10 at positions corresponding to the respective second direction indicating locations M2₁, M2₂, M2₃, . . . .

Here, the push parts 45 may formed by various methods. For example, push buttons or push keys which are provided on the input unit 10 at positions corresponding to the respective second direction indicating locations M2₁, M2₂, M2₃, . . . may be used as the push parts 45. Alternatively, the input unit 10 may be made of elastic material so that portions thereof corresponding to the respective second direction indicating locations M2₁, M2₂, M2₃, . . . can be pushed and varied in shape by pressing thus serving as the push parts 45. That is, the realization of the push parts 45 used in the second embodiment of the present invention is not limited to any special method, as long as the second directional input M2 can be performed in a pushing manner other than a method of tilting the input unit 10.

As shown in FIG. 7, the second piezoelectric sensing part 40 is provided between the input unit 10 and the base 80 and generates a second sensing signal proportional to the tilting force of the input unit or the pushing pressure of the push part 45 at the time of the second directional input M2.

As shown in FIG. 7a, the second piezoelectric sensing part 40 may have size and shape corresponding to the planar shape of the input unit 10. Alternatively, the second piezoelectric sensing part 40 may have a ring shape in which the central portion thereof is empty.

Furthermore, the second piezoelectric sensing part 40 may comprise a plurality of second piezoelectric sensing parts 40 which are provided under the lower surface of the input unit 10 at positions corresponding to the respective second direction indicating locations M2₁, M2₂, M2₃, . . . or, alternatively, it may have an integrated structure and be formed into a single body.

In the case of the second piezoelectric sensing part 40 having an integrated structure, portions of the second piezoelectric sensing part 40 are demarcated by several second deformation preventing depressions 41 according to the respective second direction indicating locations M2₁, M2₂, M2₃, . . . .

Here, the second deformation preventing depressions 41 may be formed in various directions and, for example, as shown in FIG. 7a, they may be formed towards the input unit 10 or, as shown in FIG. 7b, they may be formed towards the base 80.

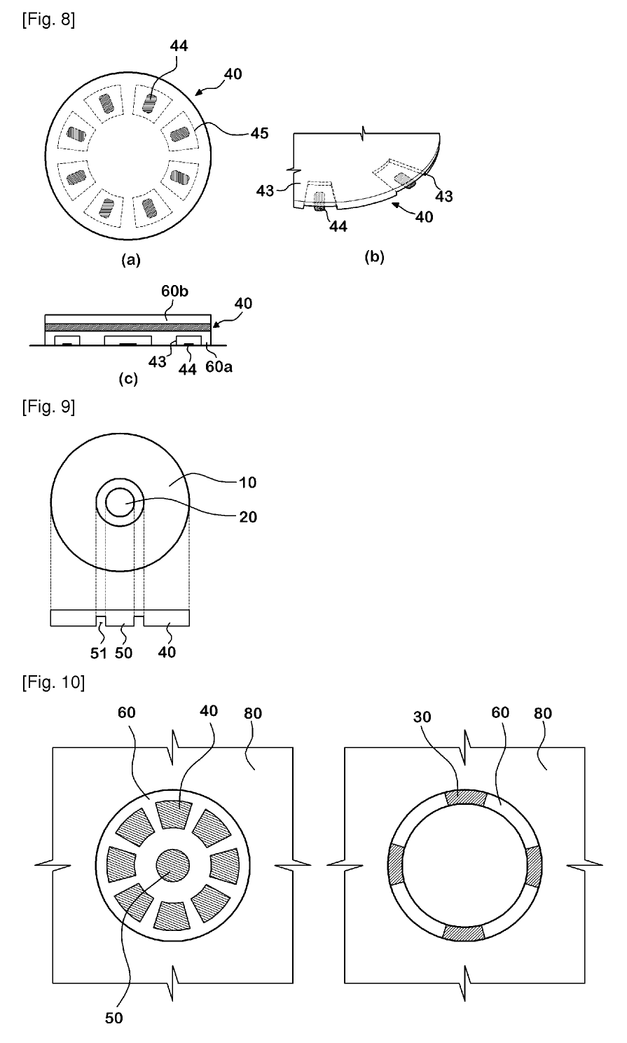

As shown in FIG. 8, spacing recesses 43 may be formed in the second piezoelectric sensing part 40 at positions corresponding to the respective second direction indicating locations M2₁, M2₂, M2₃, . . . . The spacing recesses 43 correspond to the above-mentioned concave recesses 32 of the first piezoelectric sensing part 30. A second contact sensing member 44 is provided in each spacing recess 43 so that when the second piezoelectric sensing part 40 is varied in shape by pressing a contact signal is generated by a contact made with the second piezoelectric sensing part 40 separately from a sensing signal generated by the variation in shape of the second piezoelectric sensing part 40.

Here, as shown in FIG. 8b, the second contact sensing members 44 may be disposed on the base 80 or, alternatively, they may be disposed on the second piezoelectric sensing part 40.

Furthermore, as shown in FIG. 7b or 8b, a conductive elastic member 60 may be provided on each of the opposite surfaces of the second piezoelectric sensing part 40.

In the case where the conductive elastic members 60 are provided, as shown in FIG. 7b, each second deformation preventing depression 41 may be formed through both the second piezoelectric sensing part 40 and a conductive elastic member 60a or, alternatively, as shown in FIG. 8c, it may be formed only in the conductive elastic member 60a.

The second directional input M2 may be performed in two or more steps, that is, in multiple steps depending on the intensities of signals detected from the second piezoelectric sensing part 40.

Meanwhile, a central input unit 20 which performs a central input C may be further provided in the central portion of the input unit 10 so as to be movable upwards and downwards.

The central input C may be constructed such that a letter, a numeral, a symbol or a desired functional instruction assigned thereto is independently selected. Alternatively, the central input C may be performed in combination with the first directional input M1 or the second directional input M2 (in other words, in a state in which the central input C has been performed, the first directional input M1 or the second directional input M2 may be performed).

In this case, as shown in FIG. 9, a third piezoelectric sensing part 50 which senses a pressing force attributable to the downward movement of the central input unit 20 is provided below the central input unit 20.

The third piezoelectric sensing part 50 may be independently provided below the input unit 10. Alternatively, as shown in FIG. 9, the third piezoelectric sensing part 50 may be integrally formed with the second piezoelectric sensing part 40, in which they may be demarcated by a central deformation preventing depression 51.

Although, in the first and second embodiments, the first piezoelectric sensing part 30 for sensing the first directional input M1 and the second piezoelectric sensing part 40 for sensing the second directional input M2 have been illustrated separately from each other, only one selected from between the first piezoelectric sensing part 30 and the second piezoelectric sensing part 40 must not be used. In other words, as shown in FIG. 1, the first and second piezoelectric sensing parts 30 and 40 may be used together and, in particular, they may form an integrated structure into a single body.

Furthermore, in the data input device according to the present invention, the first piezoelectric sensing part 30, the second piezoelectric sensing part 40 or the third piezoelectric sensing part 50 can be mass-produced by a forming method using a mold (or a die), thus enhancing the productivity, and making a reduction in the size of the data input device possible. In addition, the reliability of the operation of the device can be enhanced.

As well, because the data input device according to the present invention does not require several sensors to correspond to the number of the first direction indicating locations M1₁, M1₂, M1₃, . . . or the second direction indicating locations M2₁, M2₂, M2₃, . . . , the production cost can be reduced.

Moreover, it is not necessary to install several sensors on moving paths of the input unit 10 or portions of the input unit 10 corresponding to the respective second direction indicating locations M2₁, M2₂, M2₃, . . . , and it is required only to mount the piezoelectric sensing part that can be formed using a mold to the input unit 10. Therefore, the assembly of the data input device is simplified, and the production time is reduced, so that it can be easily adapted for mass production.

In the case of the piezoelectric sensing part having an integrated structure, the structure of the data input device can be simplified and the size of the device can be thus reduced. Furthermore, unlike the complex structure having several sensors, malfunction of the device is markedly reduced, thus enhancing the operational reliability.

In each embodiment, as shown in FIG. 10, the data input device may be constructed such that the piezoelectric sensing parts 30 and 40 are separately provided and a medium, such as silicone, is charged therebetween. In this case, the assemblability is increased, and the ability to attach the device to a circuit board is enhanced.

A conductive member to which a ground signal is connected is attached (or electrically connected) to a first surface of each piezoelectric sensing part 30, 40, and conductive members through which different input port signals flow are attached (or electrically connected) to second surfaces of the respective piezoelectric sensing parts 30 and 40.

Particularly, the conductive member, to which a ground signal is connected, is preferably processed by shielding treatment that encloses the piezoelectric sensing part 30, 40, thus preventing noise.

Meanwhile, an elastic rubber piezoelectric element or a solid ceramic piezoelectric element may be used as the piezoelectric sensing part 30, 40. In place of the conductive elastic member 60a or 60b seen in FIGS. 4 through 9, conductive paint may be applied to the piezoelectric sensing part or a metal element may be attached thereto.

### Third Embodiment

Next, a data input device according to a third embodiment of the present invention will be explained in detail.

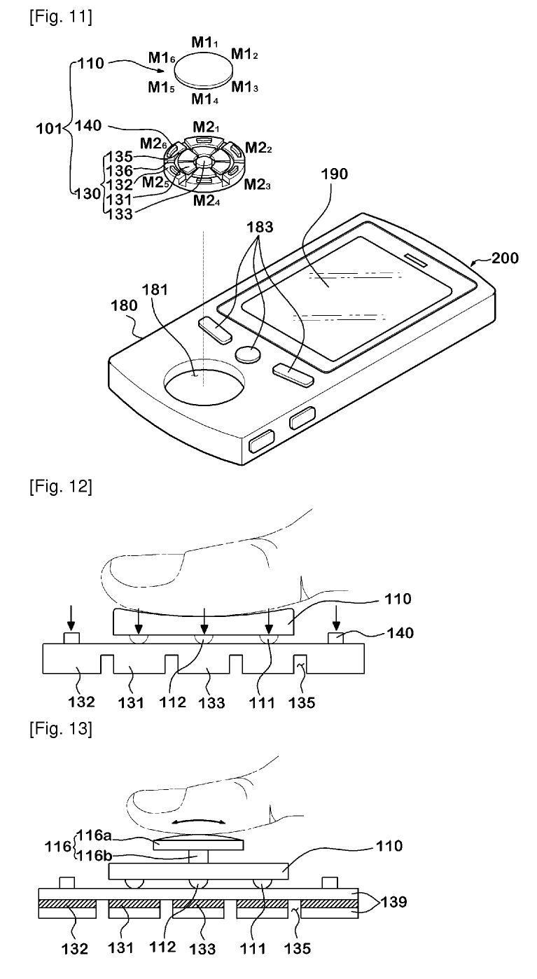

FIGS. 11 through 13 illustrate the data input device 101 according to the third embodiment of the present invention.

Referring to the drawings, the data input device 101 according to the present invention includes an input unit 110, which is provided so as to be tiltable from a horizontal state in first radial directions M1₁, M1₂, M1₃, . . . , and a plurality of first piezoelectric sensing parts 131, which are provided below the input unit 110 at positions corresponding to the first radial directions M1₁, M1₂, M1₃, . . . . Each of the first piezoelectric sensing parts 131 generates a first sensing signal proportional to a tilting pressure of the input unit 110. The data input device 101 further includes a plurality of second piezoelectric sensing parts 132, which are arranged along the outer edges of the first piezoelectric sensing parts 131 at positions corresponding to second directions M2₁, M2₂, M2₃, . . . . Each of the second piezoelectric sensing parts 132 generates a second sensing signal proportional to a pushing pressure. The data input device 101 further includes a plurality of push parts 140, which are provided on the respective second piezoelectric sensing parts 132, and a control unit, which when the first sensing signal or the second sensing signal is greater than a preset value, extracts from a memory unit data assigned to the radial direction corresponding to the relevant piezoelectric sensing part and inputs the data.

FIG. 11 is a perspective view of a portable mobile communication terminal having the data input device 101 according to the present invention. Referring to the drawing an input radius circle 181 is formed in a predetermined portion of a base 180. A display 190 which displays information input through the input unit 110 and several functional keys 183 are provided in another predetermined portion of the base 180.

The input unit 110 is provided in the input radius circle 181 provided on the base 180 and is tiltable from the horizontal state to the first radial directions.

Here, the input unit 110 may have various shapes. For example, as shown in FIG. 11, the input unit 110 may have a disk shape or, alternatively, it may have a polygonal plate shape or a rod shape having various cross-sectional shapes.

As shown in FIG. 12, the upper surface of the input unit 110 onto which the finger of a user is placed has a concave shape corresponding to the shape of the user's finger, thus facilitating the determination of the location of the finger and the operation of tilting the input unit 110.

Furthermore, as shown in FIGS. 15, 16 and 17, an anti-slip means having various shapes may be provided on the input unit 110 to prevent the finger from slipping when manipulating the input unit 110.

In addition, as shown in FIG. 13, a separate manipulator 116 protrudes from the upper surface of the input unit 110 to enable the user to easily tilt the input unit 110.

The manipulator 116 may have various shapes and, for example, it may include a manipulation end 116a on which the finger of the user is placed, and a manipulation support 116b. In this case, because the manipulator 116 has an upward protruding shape like a joystick, the user places his/her finger on the manipulation end 116a and can easily tilt the input unit 110 in a desired first radial direction M1₁, M1₂, M1₃, . . . .

The first radial direction M1₁, M1₂, M1₃, . . . may be variously changed as necessary. For example, as shown in FIG. 11, six directions may be provided or, alternatively, as shown in FIG. 16, five directions may be provided. Of course, seven or more or four or less first radial directions M1₁, M1₂, M1₃, . . . may be provided.

The term “first radial direction M1₁, M1₂, M1₃, . . . ” means a direction in which the input unit 110 is tilted. Data which is input by the tilting notion of the input unit 110 is pre-assigned to each first radial direction M1₁, M1₂, M1₃, . . . .

Here, the data may be a letter, numeral or symbol or include various functional instructions, such as an enter key-type instruction, a space, a canceling instruction, etc., or instructions, such as rotation, enlargement or reduction of a three-dimensional shape, implemented on a computer.

The first piezoelectric sensing parts 131 are provided below the input unit 110 and sense the tilting of the input unit 110.

The first piezoelectric sensing parts 131 correspond to the respective first radial directions M1₁, M1₂, M1₃, . . . . The first piezoelectric sensing parts 131 are brought into contact with the input unit 110 when it is tilted, generate first sensing signals proportional to a tilting pressure thereof, and transmit the signals to the control unit.

Each first piezoelectric sensing part 131 changes the output of electric current or voltage depending on a variation in resistance attributable to force applied from the outside. For example, a piezoelectric sensor may be used as the first piezoelectric sensing part.

The first piezoelectric sensing parts 131 are connected to the control unit, so that when a variation in a current or voltage value generated from a relevant first piezoelectric sensing part 131 by the tilting of the input unit 110 is greater than a preset value, the control unit extracts, from the memory unit, data, which is assigned to a first radial direction M1₁, M1₂, M1₃, . . . corresponding to the relevant first piezoelectric sensing part 131, and inputs the data.

Meanwhile, as shown in FIG. 13, conductive elastic members 139 which respectively cover the upper and lower surfaces of each of the first piezoelectric sensing parts 131 may be attached to each first piezoelectric sensing part 131.

The conductive elastic members 139 cover the first piezoelectric sensing part 131 to prevent abrasion or mechanical damage to the first piezoelectric sensing part 131 and function to return the input unit 110 which has been tilted to the horizontal state using the elastic force.

Meanwhile, as shown in FIG. 12, a plurality of first pressing protrusions 111 which protrude towards the respective first piezoelectric sensing parts 131 may be preferably provided under the lower surface of the input unit 110.

Each first pressing protrusion 111 functions to focus the tilting pressure of the input unit 110 when it is tilted on a portion of the relevant first piezoelectric sensing part 131, thus enhancing the sensing ability of the first piezoelectric sensing part 131. In addition, the first pressing protrusion 111 minimizes transmission of the tilting pressure to the adjacent first piezoelectric sensing parts 131, thus preventing the tilting of the input unit 110 from being undesirably sensed by several first piezoelectric sensing parts 131.

The second piezoelectric sensing parts 132 are provided adjacent to the outer edges of the respective first piezoelectric sensing parts 131 at positions corresponding to respective second radial directions M2₁, M2₂, M2₃, . . . and generate second sensing signals proportional to pushing pressures.

In detail, the second piezoelectric sensing parts 132 are arranged outside the respective first piezoelectric sensing parts 131, that is, they are disposed at positions spaced apart from the input unit 110 outwards in radial directions. Here, as necessary, the number of second radial directions M2₁, M2₂, M2₃, . . . may be changed. For example, the same number of second radial directions M2₁, M2₂, M2₃, . . . as that of the first radial directions M1₁, M1₂, M1₃, . . . may be provided or, alternatively, the numbers thereof are different from each other.

In the same manner as the first radial directions M1₁, M1₂, M1₃, . . . , different data is pre-assigned to each second radial direction M2₁, M2₂, M2₃, . . . .

The push parts 140 function to apply pushing pressures to the corresponding second piezoelectric sensing parts 132.

The push parts 140 can be provided by various methods. For example, as shown in FIG. 11, each push part 140 may comprise a push member which is provided on the corresponding second piezoelectric sensing part 132. Alternatively, the push parts 140 may form a ring shape in which the push members are integrally coupled to each other.

Furthermore, a third piezoelectric sensing part 133 is provided inside the first piezoelectric sensing parts 131 at a position corresponding to the center of the input unit 110. In this case, a central pressing protrusion 112 which protrudes towards the third piezoelectric sensing part 133 may be further provided under the lower surface of the input unit 110.

The control unit extracts, from the memory unit, data assigned to the downward movement of the input unit 110 when receiving a sensing signal from the third piezoelectric sensing part 133, and inputs the data.

Meanwhile, when the input unit 110 is moved downwards, the third piezoelectric sensing part 133 is pushed by the central pressing protrusion 112 and thus generates a sensing signal and, simultaneously, one or more first piezoelectric sensing parts 131 may be pressed by the relevant first pressing protrusions 111 and thus undesirably generate sensing signals. As such, in the case where sensing signals are generated from the third piezoelectric sensing part 133 and the first piezoelectric sensing parts 131 at the same time, the control unit determines the sensing signal transmitted only from the third piezoelectric sensing part 133 as an effective signal.

The first piezoelectric sensing parts 131, the second piezoelectric sensing parts 132 and the third piezoelectric sensing part 133 may be separately provided in the corresponding radial directions or, alternatively, as shown in FIGS. 11 through 13, they are integrally formed with each other.

In this case, circumferential deformation preventing depressions 135 are formed between the first piezoelectric sensing parts 131 and the second piezoelectric sensing parts 132 and between the first piezoelectric sensing parts 131 and the third piezoelectric sensing part 133 to demarcate them. Radial deformation preventing depressions 136 are formed between the adjacent first piezoelectric sensing parts 131 and between the adjacent second piezoelectric sensing parts 132 to demarcate them.

Here, the circumferential deformation preventing depressions 135 and the radial deformation preventing depressions 136 function to prevent a pressing force applied to one of the piezoelectric sensing parts from being undesirably transmitted to adjacent piezoelectric sensing parts, and the depressions 135 and 136 are not limited to a special shape or size, that is, they can have various shapes or sizes.

Therefore, as stated above, in the case where the first piezoelectric sensing parts 131, the second piezoelectric sensing parts 132 and the third piezoelectric sensing parts 133 are integrally formed with each other, it is not necessary to provide several separate sensors for sensing respective directional inputs. Therefore, the production cost can be reduced, and the number of manufacturing processes can be minimized using injection molding method or the like. In addition, the installation of the components can also become convenient, so that the productivity can be enhanced.

### Fourth Embodiment

Next, a data input device according to a fourth embodiment of the present invention will be described in detail.

The data input device 101 according to the fourth embodiment of the present invention is characterized in that second piezoelectric sensing parts 132 are selectively pushed by a pressing unit 120.

In the following description of this embodiment, the same reference numerals are used to designate components corresponding to those of the third embodiment, and explanation overlapping with that of the third embodiment will be omitted to focus on the differences between this embodiment and the third embodiment.

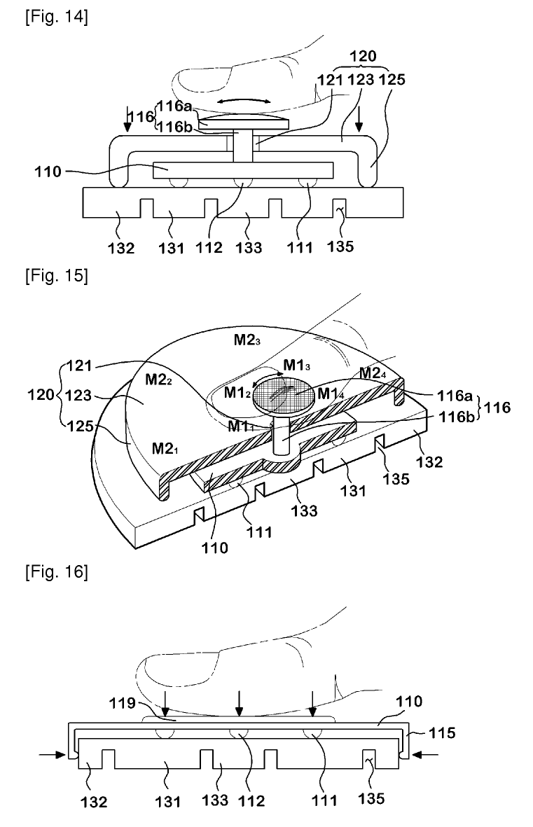

Referring to FIGS. 14 and 15, the pressing unit 120 includes a coupling part 121 to which the manipulator 116 is movably coupled, an extension part 123 which extends from the coupling part 121 towards the second piezoelectric sensing parts 132, and a pressing part 125 which is provided on the edge of the extension part 123 and presses the second piezoelectric sensing parts 132.

A manipulation support 116b is movably coupled to the coupling part 121.

The coupling part 121 may have various shapes and, for example, as shown in FIG. 14, it may comprise a through hole corresponding to the cross-section of the manipulation support 116b.

In this case, the through hole preferably has a diameter that is slightly greater than that of the cross-section of the manipulation support 116b, so that when the user manipulates the manipulation end 116b, the movement of the manipulation support 116b is prevented from interfering with the extension part 123.

The extension part 123 extends from the coupling part 121 towards the second piezoelectric sensing parts 132. The extension part 123 may also have various shapes. For example, as shown in FIG. 15, the extension part 123 may have a disk shape or, alternatively, it may have a shape of for example fan ribs or umbrella ribs.

The pressing part 125 is provided on the edge of the extension part 123 and functions to press a selected second piezoelectric sensing part 132. The pressing part 125 may also have various shapes. For example, as shown in FIG. 15, the pressing part 125 may have a shape in which it is bent from the edge of the extension part 123 towards the second piezoelectric sensing parts 132 or, alternatively, it may have a protrusion shape which protrudes from the lower surface of the extension part 123 towards the second piezoelectric sensing part 132 in the same manner as that of the first pressing protrusions 111 or the central pressing protrusion 112.

In this embodiment having the above-mentioned construction, when it is desired to select a first radial direction M1₁, M1₂, M1₃, . . . , the user tilts the manipulation end 116a in a desired radial direction. In order to select a second radial direction M2₁, M2₂, M2₃, . . . , the user pushes a portion of the extension part 123 or the pressing part 125 which corresponds to the desired radial direction.

### Fifth Embodiment

Next, a data input device according to a fifth embodiment of the present invention will be described in detail. In the following description of this embodiment, the same reference numerals are used to designate components corresponding to those of the third embodiment.

The data input device 101 according to the fifth embodiment of the present invention is characterized in that an outer edge of an input unit 110 extends towards second piezoelectric sensing parts 132 and a bent part 115 is bent downwards from the extension edge of the input unit 110 towards the sidewall of the second piezoelectric sensing parts 132.

In detail, in this embodiment, when it is desired to select a second radial direction M2₁, M2₂, M2₃, . . . , the user horizontally moves the input unit 110 in the desired second radial direction M2₁, M2₂, M2₃, . . . to apply a side pressing force to the second radial direction M2₁, M2₂, M2₃, . . . , rather than pressing a second piezoelectric sensing part 132 corresponding to the desired second radial direction M2₁, M2₂, M2₃, . . . downwards.

In this case, the selected second radial direction M2₁, M2₂, M2₃, . . . is disposed at a position diametrically opposite the second radial direction M2₁, M2₂, M2₃, . . . corresponding to the second piezoelectric sensing part 132 to which the pressing force of the input unit 110 is applied. This can be solved by changing the locations of data indicated on the input unit 110 with each other or by modifying the control unit such that it inputs data assigned to the second radial direction M2₁, M2₂, M2₃, . . . which is disposed at the opposite location.

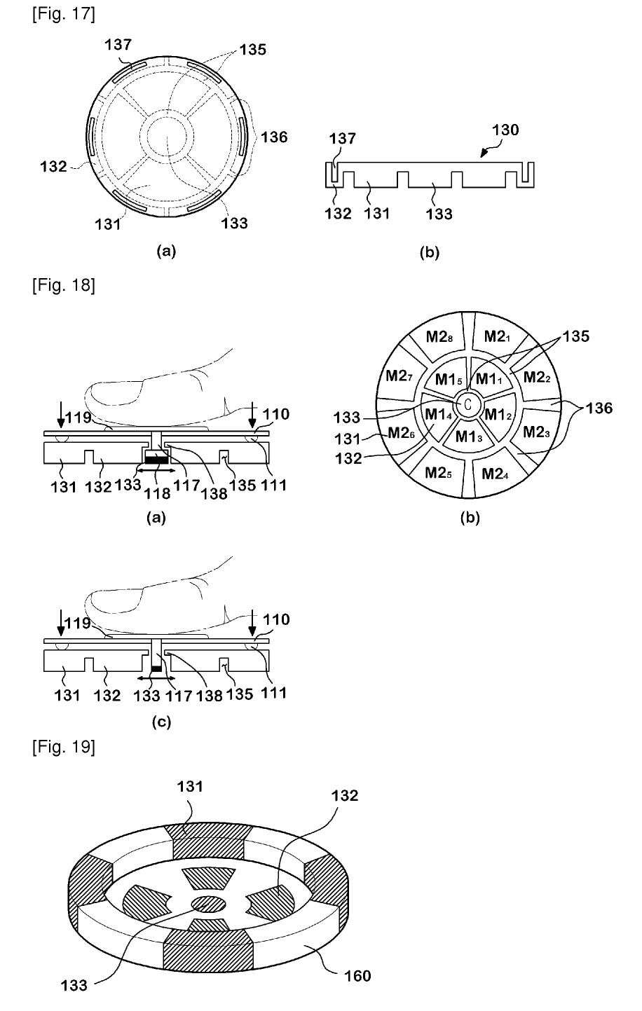

Meanwhile, as shown in FIG. 17, an elastic depression 137 may be formed in each second piezoelectric sensing part 132 at a position adjacent to the bent part 115. The elastic depression 137 enables the second piezoelectric sensing part 132 to be easily varied in shape when it is pressed by the bent part 115. Furthermore, the elastic depression 137 functions to reliably return the second piezoelectric sensing part 132 to its original state after it has been varied in shape.

### Sixth Embodiment

Next, a data input device according to a sixth embodiment of the present invention will be described. In the following description of this embodiment, the same reference numerals are used to designate components corresponding to those of the third embodiment.

The data input device 101 according to the sixth embodiment of the present invention is characterized in that second piezoelectric sensing parts 132 are pressed by an input protrusion 117 which is provided under a lower surface of an input unit 110 and a third piezoelectric sensing part 133 is disposed below the input protrusions 117.

Referring to FIG. 18, the input unit 110 is provided so as to be tiltable from a horizontal state to several first radial directions. The input protrusion 117, which has a rod shape and extends downwards, is provided under the central portion of the lower surface of the input unit 110.

The input protrusion 117 may have various shapes. For example, as shown in FIG. 18c, the input protrusion 117 may have a cylindrical rod shape or, alternatively, as shown in FIG. 18a, it may have a shape in which an extension protrusion 118 which extends towards the third piezoelectric sensing part 133 is provided on the end of the input protrusion 117.

The extension protrusion 118 functions to focus pressing force on the desired portion in the same manner as that of the first pressing protrusion 111 of the prior embodiment. Furthermore, a plurality of first pressing protrusions 111 which correspond to respective first piezoelectric sensing parts 131 is provided under the lower surface of the input unit 110.

Unlike the prior embodiments, the second piezoelectric sensing parts 132 according to this embodiment surround the input protrusion 117 and are disposed inside the first piezoelectric sensing parts 131 at positions corresponding to respective second radial directions M2₁, M2₂, M2₃, . . . .

Therefore, when the input protrusion 117 is moved by horizontal movement of the input unit 110 in the direction designated by the arrow of FIG. 18a, a first sensing signal is generated.

Furthermore, a returning part 138 which is made of elastic material and protrudes towards the input protrusion 117 may be provided at a predetermined position on each second piezoelectric sensing part 132. The returning part 138 functions to return the input protrusion 117 which has been horizontally moved to its original position.

The first piezoelectric sensing parts 131 are disposed outside the second piezoelectric sensing parts 132 at positions corresponding to respective first radial directions M1₁, M1₂, M1₃, . . . .

Here, the first piezoelectric sensing parts 131 and the second piezoelectric sensing parts 132 are integrally formed into a single body. A circumferential deformation preventing depression 135 is formed between the first piezoelectric sensing parts 131 and the second piezoelectric sensing parts 132, and radial deformation preventing depressions 136 are formed between the first piezoelectric sensing parts 131 and between the second piezoelectric sensing parts 132, thus demarcating the piezoelectric sensing parts.

The third piezoelectric sensing part 133 is provided on the end of the input protrusion 117 and thus generates a third sensing signal proportional to a pressing pressure induced by downward movement of the input unit 110.

Meanwhile, as shown in FIG. 19, the data input device according to the present invention may have an integrated structure such that piezoelectric sensing parts 131, 132 and 133 are provided in a medium, such as silicone, or a substrate 160.

In this case, because a process of separately installing the piezoelectric sensing parts at corresponding direction indicating locations is not required when manufacturing the data input device 101, the assemblability is increased and the ability to attach the device to a circuit board is enhanced.

Furthermore, first conductive members (not shown), to which input port signals which are different from each other are connected, are attached (or electrically connected) to first surfaces of the respective piezoelectric sensing parts 131, 132 and 133. Second conductive members (not shown) through which ground signals flow may be attached (or electrically connected) to second surfaces of the respective piezoelectric sensing parts 131, 132 and 133.

Particularly, the second conductive member, through which a ground signal flows, is preferably processed by shielding treatment that encloses the piezoelectric sensing part 131, 132, 133, thus preventing noise.

Meanwhile, an elastic rubber piezoelectric element or a solid ceramic piezoelectric element may be used as the piezoelectric sensing part 131, 132, 133. The conductive elastic members attached to the opposite surfaces of the piezoelectric sensing part 131, 132, 133 may be implemented by applying conductive paint to the opposite surfaces of the piezoelectric sensing part or by attaching a metal element thereto.

Next, a piezoelectric sensing unit according to the present invention will be explained.

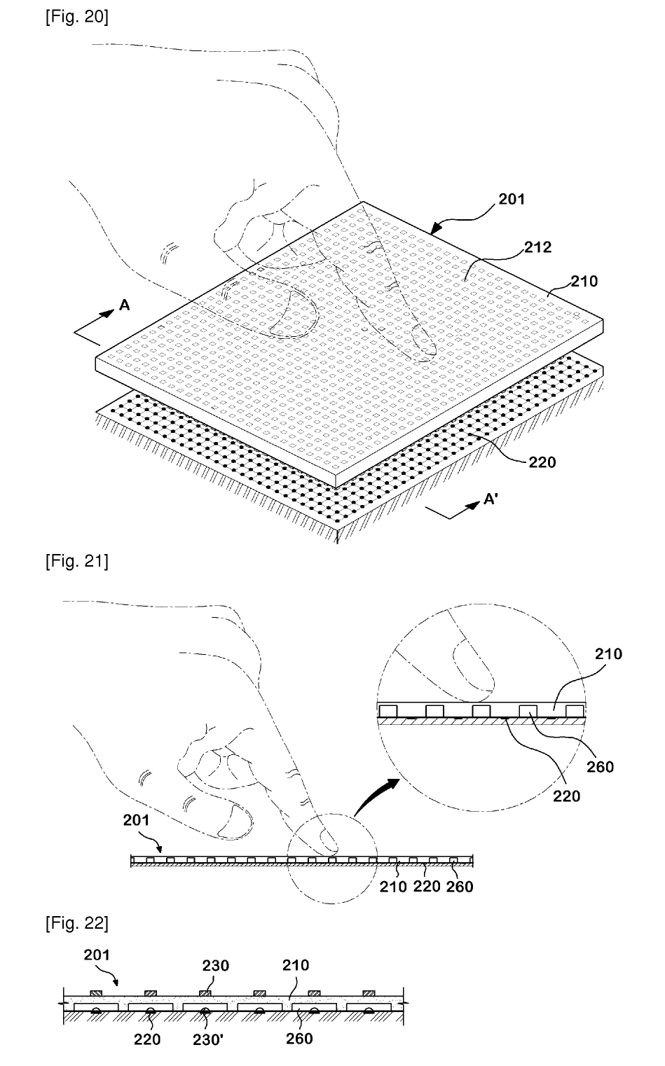

FIG. 20 is a perspective view showing a piezoelectric sensing unit 201 according to an embodiment of the present invention.

Referring to the drawing the piezoelectric sensing unit 201 according to the present invention includes a piezoelectric sensing part 210 which forms a sensing area in which a plurality of pressing locations is distributed. The piezoelectric sensing part 210 outputs a sensing signal value proportional to a pressing pressure applied to a desired pressing location. The piezoelectric sensing unit 201 further includes connection terminals 220 which are arranged at positions corresponding to the respective pressing locations and are electrically connected to the piezoelectric sensing part 210 so that the sensing signal is transmitted to the relevant connection terminal 220. The piezoelectric sensing unit 201 further includes a control unit (not shown) which, when the sensing signal is greater than a preset value, detects that the piezoelectric sensing part 210 is pressed, and which determines the pressing location using the sensing signal transmitted from the corresponding connection terminal 220.

Hereinafter, the piezoelectric sensing unit 201 will be explained, focusing on the case where it is used as a data input device.

In the case where the piezoelectric sensing unit 201 is used as the data input device, the piezoelectric sensing part 210 forms the sensing area in which the pressing locations 221 are distributed, and it outputs a sensing signal value proportional to a pressure applied to a desired pressing location 212.

The pressing locations 212 are not limited in number. Each pressing location 212 may have various shapes.

As shown in FIG. 20, the pressing locations 212 each of which has a rectangular shape may be arranged on the overall area of the piezoelectric sensing part 210 such that they are spaced apart from each other at regular intervals. Alternatively, as shown in FIG. 26, several pressing locations 212 may be arranged on the sensing area in the same manner as that of a keypad. As a further alternative, as shown in FIG. 28, pressing locations 212 may be arranged around base location S in radial directions at positions spaced apart from each other at predetermined intervals.

In the case where the pressing locations 212 are arranged on the overall area of the piezoelectric sensing part 210 at positions spaced apart from each other, the overall area of the piezoelectric sensing part 210 in which the pressing locations 212 are arranged serves as a sensing area for sensing a pressing pressure.

In the case where the pressing locations 212 are provided into a keypad type, the number of pressing locations 212 can be selectively determined as necessary. For example, as shown in FIG. 26, twelve pressing locations 212 may be provided into a typical 4×3 arrangement. Alternatively, thirteen or name pressing locations 212 may be provided.

In this case, the sensing area is formed in a manner of the keypad arrangement in response to the pressing locations 212 that are provided into a keypad type.

In the case where the pressing locations 212 are arranged in radial directions, the pressing locations 212 are also not limited in number. For example, as shown in FIG. 28, six or eight pressing locations may be formed.

In this case, the sensing area is formed in a radial shape in response to the pressing locations 212 that are formed in radial directions.

For example, at least one of a letter of a relevant country, a numeral or a symbol may be assigned to each pressing location 212. Different data may be double-assigned to each pressing location 212 to respond to a two or more step input, that is, a multiple step input, depending on the intensities of sensing signals.

The piezoelectric sensing part 210 outputs an electric current or voltage value which is changed depending on a variation in resistance attributable to a pressing force applied to a corresponding pressing location 212 by a user's finger or the like. For example, a piezoelectric sensor may be used as the piezoelectric sensing part.

The piezoelectric sensing part 210 may have various shapes, for example, as shown in FIG. 20, it may have a planar shape.

As shown in FIG. 29 or 30, the piezoelectric sensing part 210 may comprises a plurality of piezoelectric sensing parts 210 as necessary. For example, the piezoelectric sensing parts 210 may be provided in a conductive elastic member 250 which forms a substrate and be arranged at positions spaced apart from each other at regular intervals in a keypad shape or, alternatively, they may be arranged around a base location S in radial directions at positions spaced apart from each other.

The conductive elastic member 250 is provided on a side of the piezoelectric sensing part 210 and is electrically connected to one selected from between the ground and the control unit.

Thus, when the piezoelectric sensing part 210 is pressed and a current or voltage vale is thus varied, a sensing signal is transmitted to the control unit via the conductive elastic member 250, the piezoelectric sensing part 210 and the connection terminal 220.

Here, the conductive elastic member 250 may be connected to the control unit and the connection terminal 220 may be grounded.

In order to prevent noise, a coating part 214, which is treated by coating with insulation material (for example, rubber or the like), may be applied to surfaces of the conductive elastic member 250 and the piezoelectric sensing parts 210, the surfaces corresponding to the direction in which pressing pressure is applied to the piezoelectric sensing parts 210.

The conductive elastic member 250 may have various shapes and, for example, as shown in FIG. 29 or 30, it may have a rectangular plate shape corresponding to that of a printed circuit board (PCB) 270.

The conductive elastic member 250 may be made of various materials, for example, a silicone rubber of conductive material.

The PCB (printed circuit board) 270 on which various circuits for realizing the piezoelectric sensing unit 201 according to the present invention are printed is provided below the piezoelectric sensing parts 210.

Connection terminals 220 are provided on one surface of the PCB 270, which faces the piezoelectric sensing part 210, at positions corresponding to the respective piezoelectric sensing parts 210, so that a sensing signal is transmitted from each piezoelectric sensing part 210 to the corresponding connection terminal 220.

A film 280 is provided between the piezoelectric sensing parts 210 and the PCB 270.

The film 280 may have various shapes, for example, a rectangular shape corresponding to that of the piezoelectric sensing part and the PCB.

The film 280 may be made of various materials, for example, insulation material, such as rubber, to block the flow of current between the piezoelectric sensing parts 210 and the connection terminals 220.

Conductive contact members 282 are provided in the film 280 at positions corresponding to the respective piezoelectric sensing parts 210 to electrically connect the piezoelectric sensing parts 210 to the corresponding connection terminals 220, thus generating ground signals.

Each conductive contact member 282 may have various shapes, for example, as shown in FIG. 29 or 30, a ball or cylindrical shape.

Each conductive contact member 282 may be made of various materials, for example, conductive metal or silicone rubber.

Each relevant conductive contact member 282 functions to increase a ground rate between the relevant piezoelectric sensing part 210 and the relevant connection terminal 220 when a pressing pressure is applied to the piezoelectric sensing part 210.

The piezoelectric sensing part 210 does not require a separate sensor for sensing whether the piezoelectric sensing part 210 is pressed every time it is, thus reducing the production cost. As well, the number of manufacturing processes can be minimized using an injection molding method or the like. In addition, because the installation of the piezoelectric sensing part 210 is simple, the productivity can be enhanced.

The piezoelectric sensing part 210 is made of elastic material, so that when the piezoelectric sensing part 210 is pressed by the user, it is appropriately elastically varied in shape (or contracted) depending on a distance that it is pressed or the intensity of the pressing thus providing a smooth impression to the user similar to that of when touching a human's skin because of its own elastic force.

The piezoelectric sensing part 210 is connected to the control unit. When a variation in a current or voltage value generated in the piezoelectric sensing part 210 is greater than a preset value, the control unit extracts, from a memory unit, a data assigned to the relevant pressing location 212 and inputs the data.

As shown in FIG. 22, first pressing protrusions 230 or second pressing protrusions 230′ may be provided on the upper surface of the piezoelectric sensing part 210 or under the lower surface thereof which comes into contact with the connection terminals 220 to focus a pressing force applied from the outside on the relevant pressing locations 212, thus enhancing the sensing efficiency.

Each first pressing protrusion 230 or each second pressing protrusion 230′ may have various shapes, for example, as shown in FIG. 22, a hemispheric or dome shape in which it protrudes from the relevant connection terminal 220 towards the piezoelectric sensing part 210, or a rectangular box or cylindrical shape in which it protrudes in a direction opposite the direction in which the piezoelectric sensing part 210 is pressed.

Furthermore, the first pressing protrusions 230 or the second pressing protrusions 230′ are not limited in number. For example, as shown in FIG. 22, only either the first pressing protrusions 230 or second pressing protrusions 230′ may be provided on either the upper or lower surface of the piezoelectric sensing part 210. Alternatively, the first pressing protrusions 230 or the second pressing protrusions 230′ may be provided on both the upper and lower surfaces of the piezoelectric sensing part 210.

Furthermore, the first pressing protrusions may be provided on the upper surface of the piezoelectric sensing part 210 and the second pressing protrusions may be provided under the lower surface of the piezoelectric sensing part 210 which comes into contact with the connection terminals 220, or, alternatively, they may be provided in the vice-versa, switched locations.

When a pressing pressure is applied to one of the first pressing protrusions 230 which are provided on the piezoelectric sensing part 210, a portion of the piezoelectric sensing part 210 on which the relevant first pressing protrusion 230 is disposed is bent towards the corresponding connection terminal 220 and comes into contact with the corresponding second pressing protrusion 230′.

When the piezoelectric sensing part 210 comes into contact with the second pressing protrusion 230′, the second pressing protrusion 230′ is compressed towards the connection terminal 220, thus providing a feeling of a click to the user. Furthermore, in the case where a multiple step input is performed, the intensity of pressing pressure can be discriminated.

Each first pressing protrusion 230 or each second pressing protrusion 230′ may be made of various materials, for example, conductive metal or silicone rubber, etc.

If the first pressing protrusion 230 of the second pressing protrusion 230′ is made of conductive material, when a pressing pressure is applied to the piezoelectric sensing part 210, a ground rate between the relevant connection terminal 220 and the piezoelectric sensing part 210 can be enhanced.

Furthermore, each first pressing protrusion 230 or each second pressing protrusion 230′ minimizes transmission of pressing pressure to other pressing locations 212 adjacent to the corresponding pressing location 212 when the pressing is performed, thus preventing the pressing from being detected at several pressing locations 212.

As the number of pressing locations 212 is increased, the effect of transmission of the pressure of pressing to the vicinity of the corresponding pressing location 212 becomes further increased.

For example, in the case where the pressing locations 212 are disposed in the overall area of the piezoelectric sensing part 210 at positions spaced apart from each other at relatively small intervals, the pressing input may not be limited to the corresponding pressing location 212. That is, the pressing input may be detected at other pressing locations 212 adjacent to the corresponding pressing location 212. However, in the case where the first pressing protrusions 230 or the second pressing protrusions 230′ are used, they make it possible to perform the pressing only at the corresponding pressing location 212, thus preventing the pressing from being undesirably detected at other pressing locations 212 adjacent to the corresponding pressing location 212.

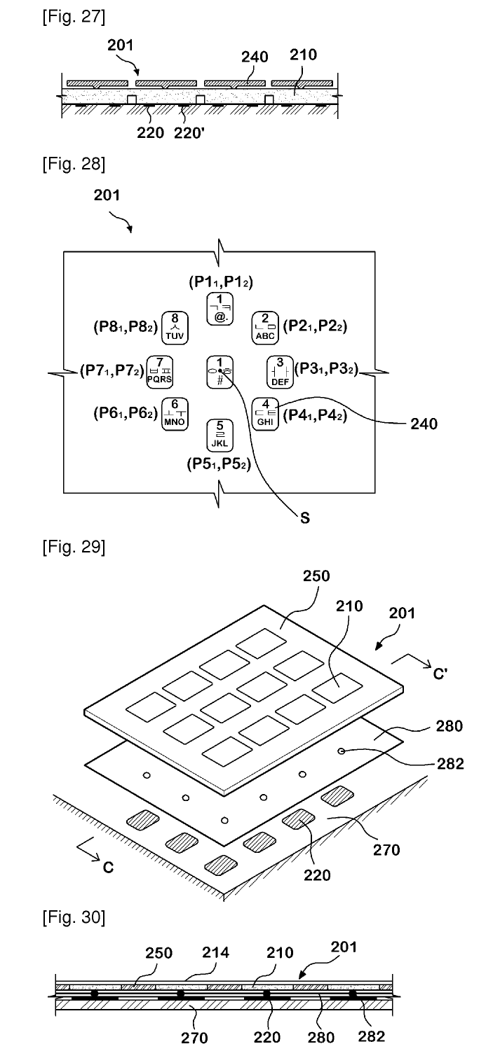

As shown in FIGS. 26 through 28, push plates 240 may be provided on the piezoelectric sensing part 210 at positions corresponding to the respective pressing locations 212 to focus the pressure of pressing on the corresponding pressing locations.

The push plates 240 may have various shapes and are not limited in number. As shown in FIG. 26, in the case where the pressing locations 212 are provided into a keypad type, twelve push plates 240 may be provided at positions corresponding to the respective pressing locations 212 into a typical 4×3 arrangement. Alternatively, thirteen or name push plates 240 may be provided. As shown in FIG. 28, in the case where the pressing locations 212 are arranged in a radial shape, six or eight push plates 240 may be provided at positions corresponding to the respective pressing locations 212.

Letters, numerals or symbols assigned to the respective pressing locations are marked on the corresponding push plates 240 such that the user can easily observe input data when pressing the push plates 240.

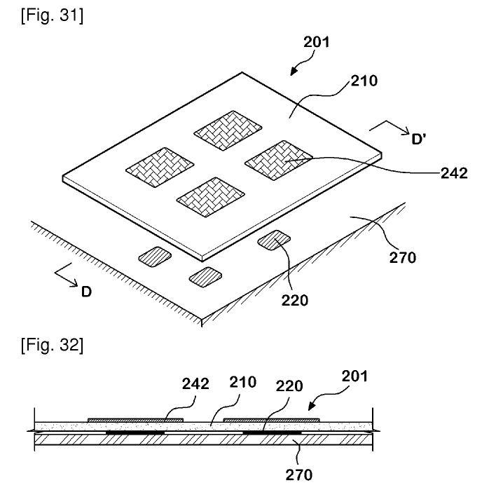

Meanwhile, as shown in FIG. 31 or 32, the piezoelectric sensing unit of the present invention may be constructed such that conductive input plates 242 are provided at predetermined positions on one surface of a piezoelectric sensing part 210 onto which pressing pressure is applied from the outside.

The number of conductive input plates 242 may be changed as necessary. For example, as shown in FIG. 31 or 32, the conductive input plates 242 may be provided in a keypad shape or, alternatively, they may be arranged around a base location S at positions spaced apart from each other.

Each conductive input plate 242 may have various shapes. For example, as shown in FIG. 31 or 32, the conductive input plate 242 may have a rectangular shape similar to that of a key of a typical keypad or, alternatively, it may have a circular or rhombus shape.

A conductive substance, such as a silver foil, may be applied to one surface of each conductive input plate 242 onto which pressing force is applied from the outside.

The conductive input plates 242 corresponding to the respective pressing locations 212 and thus focus pressing force on the corresponding pressing locations 212.

Letters, numerals or symbols assigned to the respective pressing locations 212 are marked on the corresponding conductive input plates 242, so that the user can easily observe input data when pressing the conductive input plates 242.

A PCB (printed circuit board) 270 on which various circuits for realizing the piezoelectric sensing unit 201 according to the present invention are printed is provided below the piezoelectric sensing part 210 on which the conductive input plates 242 are arranged.

Furthermore, connection terminals 220, to which sensing signals are transmitted from the piezoelectric sensing part 210, are arranged at positions corresponding to the respective conductive input plates 242 on the surface of the PCB 270 which faces the piezoelectric sensing part 210.

In this case, either the conductive input plates 242 or the connection terminals 220 are grounded to the piezoelectric sensing part 210, and the other is connected to the control unit to receive sensing signals from the piezoelectric sensing part 210 and transmit the signals to the control unit.

In the case where the connection terminals 220 are connected to the control unit, the connection terminals 220 may be connected to a central processing unit (CPU) and thus transmit sensing signals from the piezoelectric sensing part 210 to the control unit.

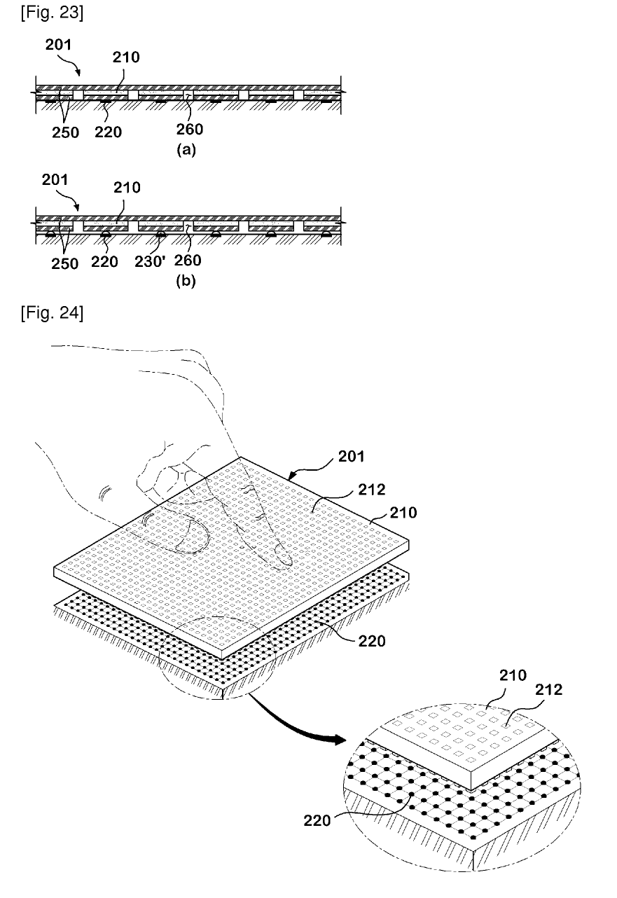

Furthermore, as shown in FIGS. 23a and 23b, a conductive elastic member 250 which covers the upper and lower surfaces of the piezoelectric sensing part 210 may be further provided on the piezoelectric sensing part 210.

The conductive elastic member 250 which covers the piezoelectric sensing part 210 functions to prevent abrasion or mechanical damage to the piezoelectric sensing part 210 and return the piezoelectric sensing part 210 which has been pressed and bent to its original horizontal state using the elastic force.

In addition, as shown in FIG. 23b, first pressing protrusions 230 or second pressing protrusions 230′ are provided between the conductive elastic member 250 and the connection terminals 220, thus enhancing a ground rate between the piezoelectric sensing part 210 and the connection terminal 220.

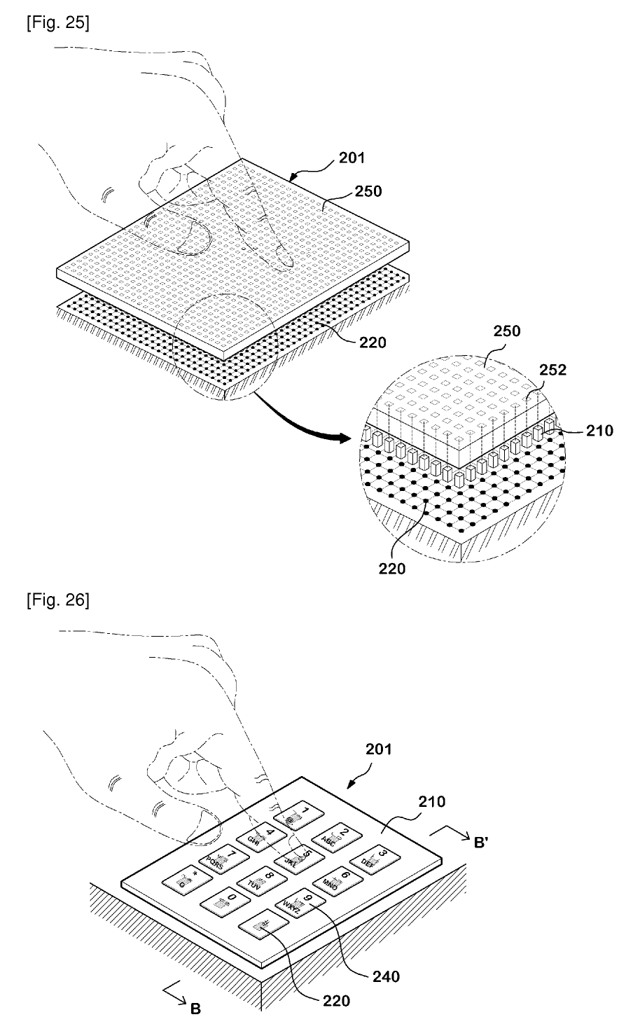

As shown in FIG. 25, receiving holes 252 which are depressed towards the first pressing protrusions 230 may be formed in the lower surface of the conductive elastic member 250 at positions corresponding to the respective connection terminals 220.

Piezoelectric sensing parts 210 are fitted into the respective receiving holes 252.

Furthermore, a clicking unit (not shown) may be provided on the perimeter of the lower end of the piezoelectric sensing part 210 or the lower end of the push plate 240, so that when a multiple step input is performed, the intensity of the pressure of pressing can be discriminated, or the feeling of a click can be transmitted to the user using the elastic force.

The piezoelectric sensing parts 210 can be demarcated by several deformation preventing depressions 260 according to the corresponding pressing locations.

The deformation preventing depressions 260 may have various shapes and sizes, for example, as shown in FIG. 28, they may be formed by depressions which cross over each other in longitudinal and lateral directions.

The deformation preventing depressions 260 are formed between the pressing locations so that the variation in shape of a piezoelectric sensing part 210 due to a pressing force applied to the relevant pressing location is prevented from being transmitted to the neighboring pressing locations.

For example, when pressing is performed at a pressing location 212, elastic variation in shape of a piezoelectric sensing part 210 attributable the pressing force may not be limited to the relevant pressing location 212, but it may occur at other pressing locations 212. However, in the case where the deformation preventing depressions 260 are formed, the pressing force can be prevented from being undesirably transmitted to the other pressing locations 212.

As such, in the piezoelectric sensing part 210 according to the present invention, the pressing locations 212 are demarcated by the deformation preventing depressions 260, so that the pressing force is prevented from being undesirably transmitted to other neighboring pressing locations 212 other than the relevant pressing location 212. Thus, the pressing can be easily detected at the relevant pressing location 212. Therefore, a separate sensor is not required, so that the production cost can be reduced and the assemblability can be enhanced.

The connection terminals 220 are disposed in the respective deformation preventing depressions 260 at positions corresponding to the respective pressing locations 212 and detect contact with the corresponding portions of the piezoelectric sensing part 210 pressed by a pressing force of the user.

The piezoelectric sensing part 210 can be sectioned into the several portions by the deformation preventing depressions 260 according to the corresponding pressing locations.

The connection terminals 220 are electrically connected to the piezoelectric sensing part 210. Thus, when pressing is performed, the relevant connection terminal 220 receives a sensing signal from the piezoelectric sensing part 210 and transmits the signal to the control unit.

As shown in FIG. 20, the connection terminals 220 may be disposed at positions corresponding to the pressing locations that are arranged on the overall area of the piezoelectric sensing part 210 at positions spaced apart from each other at regular intervals. Alternatively, as shown in FIGS. 24 and 25, the connection terminals 220 may be arranged into a checkerboard shape which includes several rows and lines that cross over each other along x-axes and y-axes.

Furthermore, if the pressing locations 212 are disposed into a keypad type arrangement or a radial arrangement at positions spaced apart from each other, the connection terminals 220 may also be disposed into a keypad type arrangement or a radial arrangement to detect pressing inputs performed at the corresponding pressing locations 212.

In the case where the connection terminals 220 are spaced apart from each other, when pressing is performed, only a connection terminal 220 disposed at the relevant pressing location 212 receives a sensing signal from the piezoelectric sensing part 210 and transmits the signal to the control unit.

In the case where the connection terminals 220 are provided in a checkerboard shape, the connection terminals 220 are arranged such that intersecting points between the x-axes and the y-axes correspond to the respective pressing locations 212.

In this case, if the number of x-axis rows is twenty and the number of y-axis lines is twenty, the total number of intersecting points between the x-axes and the y-axes corresponding to the respective pressing locations 212 is 400=the number of x-axis rows (20)×the number of y-axis lines (20). Furthermore, as necessary, the number of intersecting points may be varied in response to the number of pressing locations 212, that is, it is not limited in number.

When pressing is performed, the relevant pressing location 212 comes into contact with the point of intersection between the corresponding x-axis and y-axis, so that the corresponding terminal 220 which is disposed at the point of intersection receives a sensing signal from the piezoelectric sensing part 210 and transmits the signal to the control unit.

In the case of the connection terminals 220 of the checkerboard arrangement, the points of intersection are connected to the control unit by a pin switch method using a minimum number of input ports (for example, using a single pin). Thus, the production cost can be reduced and the target pressing location can be precisely determined.

Meanwhile, several connection terminals 220 may be provided below the piezoelectric sensing part 210 at positions adjacent to the perimeter of each deformation preventing depression 260 such that the connection terminals 220 are demarcated by the deformation preventing depressions 260.

In this case, one (for example, the connection terminal 220) of the connection terminals 220 and 220′ is grounded to the piezoelectric sensing part 210 and a remaining one (for example, the connection terminal 220′) is connected to the control unit, so that they receive a sensing signal from the piezoelectric sensing part 210 and transmit the signal to the control unit.

When pressing is performed at a target pressing location 212, the control unit determines that the pressing is performed only when a sensing signal value transmitted by variation in a current or voltage value generated in the piezoelectric sensing part 210 is greater than a preset value (for example, if the preset value is ‘1’, only when the sensing signal value is greater than ‘1’). Furthermore, the control unit discriminates the pressing location corresponding to the connection terminal 220 from which the sensing signal transmitted.

The control unit extracts, from the memory unit, one or more datum of a letter, numeral or symbol assigned to the relevant pressing location 212 at which the pressing is performed, and performs the input.

The control unit may be constructed such that it can determine sensing signals output from the single pressing location as two or more step signals, that is, multiple step signals, depending on the intensities of the sensing signals, thus rendering multiple step input possible.

In other words, after sensing signals are preset such that they are classified into two or more steps, when a sensing signal is detected in the piezoelectric sensing part 210, the intensity of the sensing signal is compared to the preset values. Thus, if the sensing signal is greater than a first preset value, a first input is performed, and if it is greater than a second preset value, a second input is performed.

For example, in the case where a multiple step input is performed, as shown in FIG. 28, if a sensing signal is greater than a first preset value, the numeral ‘1’, which is data that is assigned to the relevant pressing location and corresponds to the first step input (P1₁), is input. If a sensing signal is greater than a second preset value, the symbol ‘ [symbol] ’ of the Korean alphabet, which is data that is double-assigned to the relevant pressing location and corresponds to the second step input (P1₂), is input.

In this case, the number of data assigned to each pressing location 212 can be increased without restriction, so that the capacity of input can be maximized.

In the case where a multiple step input is performed, the user may input data by a rubbing input method in which the user performs a pressing input at a first target pressing location 212 and continuously performs pressing inputs while moving his/her finger to adjacent pressing locations 212.

In this case, multiple step inputs can be performed by varying the intensity of the pressure of pressing applied to each target pressing location 212.

The above-mentioned piezoelectric sensing part 210 may be used to input data in a touch pad and it is operated by sensing the movement of a user's finger and the pressure of pressing the pad downwards or a touch screen in which a location at which the user's finger comes into contact with the screen is discerned and desired data is processed by software located at the relevant location. Furthermore, the piezoelectric sensing part 210 may be applied to the outer surface of a robot to function similar to the skin of a human body.

Although the preferred embodiments of the present invention have been disclosed for illustrative purposes, the present invention is not limited to the embodiments or the attached drawings, and those skilled in the art will appreciate that various modifications, additions and substitutions are possible, without departing from the scope and spirit of the invention.

1. A data input device, comprising:
a base;
an input unit to perform a first directional input in such a way that the input unit moves to one of first direction indicating locations arranged around a base location in radial directions at positions spaced apart from each other within a predetermined input radius defined on the base;
first piezoelectric sensing parts provided on respective moving paths of the input unit, so that when the first directional input is performed, the corresponding first piezoelectric sensing part is pressed by a pressing force by the input unit, thus generating a first sensing signal proportional to the pressing force; and
a control unit to extract and input data from a memory unit when the first sensing signal is greater than a preset value, the data being assigned to the corresponding first direction indicating location at which movement of the input unit is sensed.

2. The data input device according to claim 1, wherein the first piezoelectric sensing parts are provided between the base and the input unit at positions which correspond to the respective first direction indicating locations and are spaced apart from the input unit by predetermined distances.

3. The data input device according to claim 2, wherein the first piezoelectric sensing parts are provided around an outer edge of the input unit and are integrated with each other into a single body, and first deformation preventing depressions are formed in the first piezoelectric sensing parts between the adjacent first direction indicating locations.

4. The data input device according to claim 2, further comprising:
a pressing ring provided between the first piezoelectric sensing parts and the input unit, the pressing ring having pressing protrusions which protrude towards the respective first piezoelectric sensing parts at positions corresponding to the respective first direction indicating locations.

5. The data input device according to claim 3, wherein the first piezoelectric sensing parts form a sine wave shape in which concave recesses and convex portions are repeatedly formed, the concave recesses being formed in first surfaces of the first piezoelectric sensing parts, which face the base, at positions corresponding to the respective first direction indicating locations, the convex portions being formed on second surfaces of the first piezoelectric sensing parts such that the convex portions protrude towards the input unit.

6. The data input device according to claim 5, further comprising:
first contact sensing members provided on the base at positions corresponding to the respective concave recesses to detect a contact formed with the first piezoelectric sensing parts pushed by the pressing force of the input unit.

7. (canceled)

8. The data input device according to claim 1, wherein the first directional input is provided to be performed in two or more steps, that is, in multiple steps, depending on an intensity of a sensing signal sensed in the first piezoelectric sensing parts.

9. A data input device, comprising:
a base;
an input unit provided on the base, the input unit performing a second directional input in such a way that the input unit is tilted towards one of second direction indicating locations which are radially provided on the input unit at positions spaced apart from each other, or in such a way that one of push parts which are provided in the input unit at positions corresponding to the respective second direction indicating locations is selected;
a second piezoelectric sensing part provided between the input unit and the base, the second piezoelectric sensing part generating a second sensing signal proportional to a tilting pressure of the input unit or a pushing pressure applied to the corresponding push part when the second directional input is performed; and
a control unit to extract and input data from a memory unit when the second sensing signal is greater than a preset value, the data being assigned to the corresponding second direction indicating location at which the tilting of the input unit or the selection of the corresponding push part is sensed.

10. The data input device according to claim 9, wherein the second piezoelectric sensing part comprises a plurality of second piezoelectric sensing parts which are provided below the input unit at positions corresponding to the respective second direction indicating locations.

11. The data input device according to claim 10, wherein the second piezoelectric sensing parts are integrated with each other into a single body, and the second piezoelectric sensing parts are demarcated by second deformation preventing depressions according to the respective second direction indicating locations.

12. The data input device according to claim 10, wherein the second piezoelectric sensing parts are integrated with each other into a single body, in which spacing recesses are formed at positions corresponding to the respective second direction indicating locations.

13. The data input device according to claim 12, further comprising:
a second contact sensing member provided on the base in each of the spacing recesses to detect a contact with the corresponding second piezoelectric sensing part pushed by the tilting pressure of the input unit or by the pushing pressure of the corresponding push part.

14. (canceled)

15. The data input device according to claim 9, wherein the second directional input is provided to be performed in two or more steps, that is, in multiple steps, depending on an intensity of a sensing signal sensed in the second piezoelectric sensing parts.

16. The data input device according to claim 9, further comprising:
a central input unit provided in a central portion of the input unit so as to be movable upwards and downwards, the central input unit performing a central input; and
a third piezoelectric sensing part provided below the central input unit.

17. The data input device according to claim 16, wherein the third piezoelectric sensing part is integrated with the second piezoelectric sensing part such that the second and third piezoelectric sensing parts are demarcated by a central deformation preventing depression.

18. The data input device according to claim 9, wherein the input unit performs a first directional input in such a way that the input unit moves to one of first direction indicating locations which are arranged around a base location in radial directions at positions spaced apart from each other, the data input device further comprising:
first piezoelectric sensing parts provided on respective moving paths of the input unit, so that when the first directional input is performed, the corresponding first piezoelectric sensing part is pressed by the input unit, thus generating a first sensing signal proportional to a pressing force.

19-20. (canceled)

21. A data input device, comprising:
an input unit provided so as to be tiltable from a horizontal state to first radial directions;
a plurality of first piezoelectric sensing parts provided below the input unit at positions corresponding to the respective first radial directions, each of the first piezoelectric sensing parts generating a first sensing signal proportional to a tilting pressure of the input unit;
a plurality of second piezoelectric sensing parts provided around outer edges of the first piezoelectric sensing parts at positions corresponding to respective second directions, each of the second piezoelectric sensing parts generating a second sensing signal proportional to a pushing pressure;
a plurality of push parts provided on the respective second piezoelectric sensing parts; and
a control unit to extract and input data from a memory unit when the first sensing signal or the second sensing signal is greater than a preset value, the data being assigned to the radial direction corresponding to the corresponding piezoelectric sensing part.

22. The data input device according to claim 21, wherein the first piezoelectric sensing parts and the second piezoelectric sensing parts are integrated with each other, wherein circumferential deformation preventing depressions are formed between the first piezoelectric sensing parts and the second piezoelectric sensing parts, and radial deformation preventing depressions are formed between the adjacent first piezoelectric sensing parts and between the adjacent second piezoelectric sensing parts, thus demarcating the piezoelectric sensing parts.

23. The data input device according to claim 21, further comprising:
a plurality of pressing protrusions provided under the input unit, the pressing protrusions protruding towards the respective first piezoelectric sensing parts.

24. (canceled)

25. The data input device according to claim 21, further comprising:
a manipulator protruding from an upper surface of the input unit to manipulate an operation of tilting the input unit; and
a pressing unit, including: a coupling part, to which the manipulator is movably coupled; an extension part extending from the coupling part towards the second piezoelectric sensing parts; and a pressing part provided on an edge of the extension part to press the second piezoelectric sensing parts.

26. (canceled)

27. The data input device according to claim 21, further comprising:
a third piezoelectric sensing part provided inside the first piezoelectric sensing parts at a position corresponding to a central portion of the input unit; and
a central pressing protrusion provided under the input unit, the central pressing protrusion protruding towards the third piezoelectric sensing part.

28-29. (canceled)

30. The data input device according to claim 21, further comprising:
an input protrusion provided centrally below the input unit, the input protrusion having a rod shape and extending downwards;
a third piezoelectric sensing part provided on an end of the input protrusion, the third piezoelectric sensing part generating a third sensing signal proportional to a pushing pressure generated by a vertical movement of the input protrusion; and
a control unit to extract and input data from a memory unit when the sensing signal is greater than a preset value, the data being assigned to the radial direction corresponding to the corresponding piezoelectric sensing part or the input protrusion.

31. The data input device according to claim 30, wherein the first piezoelectric sensing parts and the second piezoelectric sensing parts are integrated with each other, wherein circumferential deformation preventing depressions are formed between the first piezoelectric sensing parts and the second piezoelectric sensing parts, and radial deformation preventing depressions are formed between the adjacent first piezoelectric sensing parts and between the adjacent second piezoelectric sensing parts, thus demarcating the piezoelectric sensing parts.

32-34. (canceled)

35. A piezoelectric sensing unit, comprising:
a piezoelectric sensing part for forming a sensing area in which a plurality of pressing locations is distributed, the piezoelectric sensing part being made of elastic material and outputting a sensing signal proportional to a pressing force applied to one of the pressing locations;
a conductive elastic member provided on a first side of the piezoelectric sensing part, the conductive elastic being connected to one of a grounding and a control unit;
connection terminals provided on a second side of the piezoelectric sensing part at positions corresponding to the respective pressing locations, the connection terminals being connected to a remaining one of the grounding and the control unit; and
the control unit to determine a pressing of the piezoelectric sensing part when the sensing signal transmitted to the control unit is greater than a preset value, the control unit determining the pressing location from the relevant connection terminal from which the sensing signal is transmitted to the control unit.

36-45. (canceled)

46. The piezoelectric sensing unit according to claim 35, wherein the control unit discriminates and determines the sensing signal output from the single pressing location as a two or more step signal, that is, a multiple step signal, depending on an intensity of the sensing signal.

47-50. (canceled)
